(19) United States
(12) Patent Application Publication
(10) Pub. No.: US 2026/0075558 A1
(43) Pub. Date: Mar. 12, 2026

(54) TIMING ADVANCE OFFSET CONFIGURATION FOR INTER-CELL MULTIPLE DOWNLINK CONTROL INFORMATION MULTIPLE TRANSMISSION AND RECEPTION POINT OPERATION

(71) Applicant: QUALCOMM Incorporated, San Diego, CA (US)

(72) Inventors: Xiaoxia ZHANG, San Diego, CA (US); Jing SUN, San Diego, CA (US); Mostafa KHOSHNEVISAN, San Diego, CA (US); Shaozhen GUO, Beijing (CN)

(21) Appl. No.: 18/868,127

(22) PCT Filed: Jul. 27, 2022
(86) PCT No.: PCT/CN2022/108094

§ 371 Date: Nov. 21, 2024

(51) Int. Cl. H04W 56/00

(52) U.S. Cl. CPC H04W 56/0045; H04W 56/001

(57) ABSTRACT

Methods, systems, and devices for wireless communications are described. A user equipment (UE) may adjust the timing of an uplink transmission by applying a timing advance value to the uplink transmission. Timing advance offset values may depend on the cell associated with the uplink transmission. A timing advance offset value associated with each additional physical cell identifier (PCI) for a serving cell may be indicated. The network may indicate a configuration for a serving cell that includes one or two timing advance offset values for the serving cell identifier and respective timing advance offset values associated with each additional PCI for the serving cell. Each PCI may be associated with a transmission configuration indicator (TCI) state. Accordingly, the UE may apply the appropriate timing advance offset value for given uplink transmissions based on the TCI state (and therefore the PCI) associated with the given uplink transmissions.

### CROSS REFERENCE

The present Application is a 371 national stage filing of International PCT Application No. PCT/CN2022/108094 by ZHANG et al. entitled “TIMING ADVANCE OFFSET CONFIGURATION FOR INTER-CELL MULTIPLE DOWNLINK CONTROL INFORMATION MULTIPLE TRANSMISSION AND RECEPTION POINT OPERATION,” filed Jul. 27, 2022, which is assigned to the assignee hereof, and which is expressly incorporated by reference in its entirety herein.

### FIELD OF DISCLOSURE

The present disclosure, for example, relates to wireless communications, more particularly to techniques for including timing advance offset configuration for inter-cell multiple downlink control information multiple transmission and reception point (multi-DCI multi-TRP) operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timing advance offset configuration for inter-cell multiple downlink control information (multi-DCI) multiple transmission and reception point (multi-TRP) operation. A user equipment (UE) may adjust the timing of an uplink transmission by applying a timing advance value to the uplink transmission. Timing advance offset values may depend on the cell associated with the uplink transmission. A timing advance offset value associated with each additional physical cell identifier (PCI) for a serving cell may be indicated. The network may indicate, for example, via a radio resource control (RRC) message, a configuration for a serving cell that includes one or two timing advance offset values for the serving cell identifier and respective timing advance offset values associated with each additional PCI for the serving cell. Each PCI may be associated with a transmission configuration indicator (TCI) state. Accordingly, the UE may apply the appropriate timing advance offset value for given uplink transmissions based on the TCI state (and therefore the PCI) associated with the given uplink transmissions.

A method for wireless communications at a UE is described. The method may include receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first component carrier (CC), transmit a first uplink message in accordance with a first TCI state associated with the first serving cell identifier and based on the first timing advance offset value, and transmit a second uplink message in accordance with a second TCI state associated with the second cell identifier and based on the second timing advance offset.

An apparatus for wireless communications at a UE is described. The apparatus may include a processor, memory coupled with the processor, and instructions stored in the memory. The instructions may be executable by the processor to cause the apparatus to receive, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC, transmit a first uplink message in accordance with a first TCI state associated with the first serving cell identifier and based on the first timing advance offset value, and transmit a second uplink message in accordance with a second TCI state associated with the second cell identifier and based on the second timing advance offset.

Another apparatus for wireless communications at a UE is described. The apparatus may include means for receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC, means for transmit a first uplink message in accordance with a first TCI state associated with the first serving cell identifier and based on the first timing advance offset value, and means for transmit a second uplink message in accordance with a second TCI state associated with the second cell identifier and based on the second timing advance offset.

A non-transitory computer-readable medium storing code for wireless communications at a UE is described. The code may include instructions executable by a processor to receive, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC, transmit a first uplink message in accordance with a first TCI state associated with the first serving cell identifier and based on the first timing advance offset value, and transmit a second uplink message in accordance with a second TCI state associated with the second cell identifier and based on the second timing advance offset.

In some examples of the method, apparatuses, and non-transitory computer-readable medium described herein, receiving the control signaling may include operations, features, means, or instructions for receiving the control signaling including a field indicating an association between the second cell identifier and the second timing advance offset value.

In some examples of the method, apparatuses, and non-transitory computer-readable medium described herein, receiving the control signaling may include operations, features, means, or instructions for receiving the control signaling including one or more fields indicating an association between a set of cell identifier indices and a set of timing advance offset values, the set of cell identifier indices common to a set of UEs associated with the first serving cell identifier and receiving an indication of an association between the set of cell identifiers and the set of cell identifier indices.

In some examples of the method, apparatuses, and non-transitory computer-readable medium described herein, receiving the control signaling may include operations, features, means, or instructions for receiving the control signaling indicating the first CC may be associated with a first timing advance group (TAG) and a second TAG, where the first timing advance offset value, the second timing advance offset value, and additional timing advance offset values associated with the set of cell identifiers may be each associated with one of the first TAG or the second TAG and receiving the control signaling indicating a second CC associated with the first TAG and a third timing advance offset value associated with the second CC, where the third timing advance offset value may be associated with the first TAG, and where timing advance offset values associated with the first TAG in the first CC and the second CC may be equal.

In some examples of the method, apparatuses, and non-transitory computer-readable medium described herein, receiving the control signaling may include operations, features, means, or instructions for receiving the control signaling indicating the first CC associated with a first TAG and a second TAG, where the first timing advance offset value, the second timing advance offset value, and additional timing advance offset values associated with the set of cell identifiers may be each associated with one of the first TAG or the second TAG and receiving the control signaling indicating a second CC associated with at least one of the first TAG or the second TAG and a third timing advance offset value associated with the second CC, where the third timing advance offset value may be associated with the at least one of the first TAG or the second TAG, and where timing advance offset values associated with the at least one of the first TAG or the second TAG in the first CC and the second CC may be equal.

In some examples of the method, apparatuses, and non-transitory computer-readable medium described herein, receiving the control signaling may include operations, features, means, or instructions for receiving the control signaling indicating the first CC may be associated with a first TAG and a second TAG, where the first timing advance offset value, the second timing advance offset value, and additional timing advance offset values associated with the set of cell identifiers may be each associated with one of the first TAG, the second TAG, or a third TAG and receiving the control signaling indicating a second set of cell identifiers associated with a second CC, the second CC associated with at least one of the first TAG or the second TAG and a second set of timing advance offset values associated with the second set of cell identifiers, where a subset of timing advance offset values of the second set of timing advance offset values may be associated with the at least one of the first TAG or the second TAG, and where timing advance offset values associated with the at least one of the first TAG or the second TAG in the first CC and the second CC may be equal.

Some examples of the method, apparatuses, and non-transitory computer-readable medium described herein may further include operations, features, means, or instructions for receiving, from the network entity, second control signaling activating first one or more TCI states for a first control resource set (CORESET) pool index in the first CC, where the first CORESET pool index may be associated with the first serving cell identifier and a first TAG, receiving, from the network entity, third control signaling activating second one or more TCI states for a second CORESET pool index in the first CC, where the second CORESET pool index may be associated with the second cell identifier and a second TAG, and receiving, from the network entity, fourth control signaling activating third one or more TCI states associated with a second serving cell identifier for a second CC, where the second serving cell identifier may be associated with the second TAG, and where the second timing advance offset value may be equal to a third timing advance offset value associated with the second serving cell identifier.

Some examples of the method, apparatuses, and non-transitory computer-readable medium described herein may further include operations, features, means, or instructions for receiving, from the network entity, second control signaling activating first one or more TCI states for a first CORESET pool index in the first CC, where the first CORESET pool index may be associated with the first serving cell identifier and a first TAG, receiving, from the network entity, third control signaling activating second one or more TCI states for a second CORESET pool index in the first CC, where the second CORESET pool index may be associated with the second cell identifier and a second TAG, receiving, from the network entity, fourth control signaling activating third one or more TCI states associated with a third CORESET pool index for a second CC, where the third CORESET pool index may be associated with a second serving cell identifier and the first TAG, and where the first timing advance offset value may be equal to a third timing advance offset value associated with the third CORESET pool index of the second serving cell identifier, and receiving, from the network entity, fifth control signaling activating fourth one or more TCI states associated with a fourth CORESET pool index for the second CC, where the fourth CORESET pool index may be associated with the second serving cell identifier and the second TAG, and where the second timing advance offset value may be equal to a fourth timing advance offset value associated with the fourth CORESET pool index of the second serving cell identifier.

Some examples of the method, apparatuses, and non-transitory computer-readable medium described herein may further include operations, features, means, or instructions for receiving, from the network entity, second control signaling activating first one or more TCI states for a first CORESET pool index in the first CC, where the first CORESET pool index may be associated with the first serving cell identifier and a first TAG, receiving, from the network entity, third control signaling activating second one or more TCI states for a second CORESET pool index in the first CC, where the second CORESET pool index may be associated with the second cell identifier and a second TAG, receiving, from the network entity, fourth control signaling activating third one or more TCI states associated with a third CORESET pool index for a second CC, where the third CORESET pool index may be associated with a second serving cell identifier and the first TAG, and where the first timing advance offset value may be equal to a third timing advance offset value associated with the third CORESET pool index of the second serving cell identifier, and receiving, from the network entity, fifth control signaling activating fourth one or more TCI states associated with a fourth CORESET pool index for the second CC, where the fourth CORESET pool index may be associated with a third cell identifier of a second set of cell identifiers associated with the second CC and a third TAG.

Some examples of the method, apparatuses, and non-transitory computer-readable medium described herein may further include operations, features, means, or instructions for receiving, from the network entity, second control signaling activating first one or more TCI states for a first CORESET pool index for the first CC, where the first CORESET pool index may be associated with the first serving cell identifier and a first TAG, receiving, from the network entity, third control signaling activating second one or more TCI states for a second CORESET pool index for the first CC, where the second CORESET pool index may be associated with the second cell identifier and a second TAG, receiving, from the network entity, fourth control signaling activating third one or more TCI states associated with a third CORESET pool index for a second CC, where the third CORESET pool index may be associated with a third cell identifier of a second set of cell identifiers associated with the second CC and the second TAG, and where the first timing advance offset value may be equal to a third timing advance offset value associated with the third cell identifier of the second set of cell identifiers, and receiving, from the network entity, fifth control signaling activating fourth one or more TCI states associated with a fourth CORESET pool index for the second CC, where the fourth CORESET pool index may be associated with a second serving cell identifier and a third TAG.

Some examples of the method, apparatuses, and non-transitory computer-readable medium described herein may further include operations, features, means, or instructions for receiving, from the network entity, second control signaling activating first one or more TCI states for a first CORESET pool index for the first CC, where the first CORESET pool index may be associated with the second cell identifier and a first TAG, receiving, from the network entity, third control signaling activating second one or more TCI states for a second CORESET pool index for the first CC, where the second CORESET pool index may be associated with the first serving cell identifier and a second TAG, receiving, from the network entity, fourth control signaling activating third one or more TCI states associated with a third CORESET pool index for a second CC, where the third CORESET pool index may be associated with a third cell identifier of a second set of cell identifiers associated with the second CC and a third TAG, and receiving, from the network entity, fifth control signaling activating fourth one or more TCI states associated with a fourth CORESET pool index for the second CC, where the fourth CORESET pool index may be associated with a second serving cell identifier and the first TAG, and where the second timing advance offset value may be equal to a third timing advance offset value associated with the second serving cell identifier.

Some examples of the method, apparatuses, and non-transitory computer-readable medium described herein may further include operations, features, means, or instructions for receiving, from the network entity, second control signaling activating first one or more TCI states for a first CORESET pool index for the first CC, where the first CORESET pool index may be associated with the first serving cell identifier and a first TAG, receiving, from the network entity, third control signaling activating second one or more TCI state for a second CORESET pool index for the first CC, where the second CORESET pool index may be associated with the second cell identifier and a second TAG, receiving, from the network entity, fourth control signaling activating third one or more TCI states associated with a third CORESET pool index for a second CC, where the third CORESET pool index may be associated with a second serving cell identifier and a third TAG, and receiving, from the network entity, fifth control signaling activating fourth one or more TCI states associated with a fourth CORESET pool index for the second CC, where the fourth CORESET pool index may be associated with a third cell identifier of a second set of cell identifiers associated with the second CC and the second TAG, and where the second timing advance offset value may be equal to a third timing advance offset value associated with the third cell identifier.

A method for wireless communications at a network entity is described. The method may include transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC, receive, from the UE, a first uplink message in accordance with a first TCI state associated with the first serving cell identifier and based on the first timing advance offset value, and receive, from the UE, a second uplink message in accordance with a second TCI state associated with the second cell identifier and based on the second timing advance offset.

An apparatus for wireless communications at a network entity is described. The apparatus may include a processor, memory coupled with the processor, and instructions stored in the memory. The instructions may be executable by the processor to cause the apparatus to transmit, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC, receive, from the UE, a first uplink message in accordance with a first TCI state associated with the first serving cell identifier and based on the first timing advance offset value, and receive, from the UE, a second uplink message in accordance with a second TCI state associated with the second cell identifier and based on the second timing advance offset.

Another apparatus for wireless communications at a network entity is described. The apparatus may include means for transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC, means for receive, from the UE, a first uplink message in accordance with a first TCI state associated with the first serving cell identifier and based on the first timing advance offset value, and means for receive, from the UE, a second uplink message in accordance with a second TCI state associated with the second cell identifier and based on the second timing advance offset.

A non-transitory computer-readable medium storing code for wireless communications at a network entity is described. The code may include instructions executable by a processor to transmit, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC, receive, from the UE, a first uplink message in accordance with a first TCI state associated with the first serving cell identifier and based on the first timing advance offset value, and receive, from the UE, a second uplink message in accordance with a second TCI state associated with the second cell identifier and based on the second timing advance offset.

In some examples of the method, apparatuses, and non-transitory computer-readable medium described herein, transmitting the control signaling may include operations, features, means, or instructions for transmitting the control signaling including a field indicating an association between the second cell identifier and the second timing advance offset value.

In some examples of the method, apparatuses, and non-transitory computer-readable medium described herein, transmitting the control signaling may include operations, features, means, or instructions for transmitting the control signaling including one or more fields indicating an association between a set of cell identifier indices and a set of timing advance offset values, the set of cell identifier indices common to a set of UEs associated with the first serving cell identifier and transmitting an indication of an association between the set of cell identifiers and the set of cell identifier indices.

In some examples of the method, apparatuses, and non-transitory computer-readable medium described herein, transmitting the control signaling may include operations, features, means, or instructions for transmitting the control signaling indicating the first CC may be associated with a first TAG and a second TAG, where the first timing advance offset value, the second timing advance offset value, and additional timing advance offset values associated with the set of cell identifiers may be each associated with one of the first TAG or the second TAG and transmitting the control signaling indicating a second CC associated with the first TAG and a third timing advance offset value associated with the second CC, where the third timing advance offset value may be associated with the first TAG, and where timing advance offset values associated with the first TAG in the first CC and the second CC may be equal.

In some examples of the method, apparatuses, and non-transitory computer-readable medium described herein, transmitting the control signaling may include operations, features, means, or instructions for transmitting the control signaling indicating the first CC associated with a first TAG and a second TAG, where the first timing advance offset value, the second timing advance offset value, and additional timing advance offset values associated with the set of cell identifiers may be each associated with one of the first TAG or the second TAG and transmitting the control signaling indicating a second CC associated with at least one of the first TAG or the second TAG and a third timing advance offset value associated with the second CC, where the third timing advance offset value may be associated with the at least one of the first TAG or the second TAG, and where timing advance offset values associated with the at least one of the first TAG or the second TAG in the first CC and the second CC may be equal.

In some examples of the method, apparatuses, and non-transitory computer-readable medium described herein, transmitting the control signaling may include operations, features, means, or instructions for transmitting the control signaling indicating the first CC associated with a first TAG and a second TAG, where the first timing advance offset value, the second timing advance offset value, and additional timing advance offset values associated with the set of cell identifiers may be each associated with one of the first TAG, the second TAG, or a third TAG and transmitting the control signaling indicating a second set of cell identifiers associated with a second CC, the second CC associated with at least one of the first TAG or the second TAG and a second set of timing advance offset values associated with the second set of cell identifiers, where a subset of timing advance offset values of the second set of timing advance offset values may be associated with the at least one of the first TAG or the second TAG, and where timing advance offset values associated with the at least one of the first TAG or the second TAG in the first CC and the second CC may be equal.

Some examples of the method, apparatuses, and non-transitory computer-readable medium described herein may further include operations, features, means, or instructions for transmitting, to the UE, second control signaling activating first one or more TCI states for a first CORESET pool index in the first CC, where the first CORESET pool index may be associated with the first serving cell identifier and a first TAG, transmitting, to the UE, third control signaling activating second one or more TCI states for a second CORESET pool index in the first CC, where the second CORESET pool index may be associated with the second cell identifier and a second TAG, and transmitting, to the UE, fourth control signaling activating third one or more TCI states associated with a second serving cell identifier for a second CC, where the second serving cell identifier may be associated with the second TAG, and where the second timing advance offset value may be equal to a third timing advance offset value associated with the second serving cell identifier.

Some examples of the method, apparatuses, and non-transitory computer-readable medium described herein may further include operations, features, means, or instructions for transmitting, to the UE, second control signaling activating first one or more TCI states for a first CORESET pool index in the first CC, where the first CORESET pool index may be associated with the first serving cell identifier and a first TAG, transmitting, to the UE, third control signaling activating second one or more TCI states for a second CORESET pool index in the first CC, where the second CORESET pool index may be associated with the second cell identifier and a second TAG, transmitting, to the UE, fourth control signaling activating third one or more TCI states associated with a third CORESET pool index for a second CC, where the third CORESET pool index may be associated with a second serving cell identifier and the first TAG, and where the first timing advance offset value may be equal to a third timing advance offset value associated with the third CORESET pool index of the second serving cell identifier, and transmitting, to the UE, fifth control signaling activating fourth one or more TCI states associated with a fourth CORESET pool index for the second CC, where the fourth CORESET pool index may be associated with the second serving cell identifier and the second TAG, and where the second timing advance offset value may be equal to a fourth timing advance offset value associated with the fourth CORESET pool index of the second serving cell identifier.

Some examples of the method, apparatuses, and non-transitory computer-readable medium described herein may further include operations, features, means, or instructions for transmitting, to the UE, second control signaling activating first one or more TCI states for a first CORESET pool index in the first CC, where the first CORESET pool index may be associated with the first serving cell identifier and a first TAG, transmitting, to the UE, third control signaling activating second one or more TCI states for a second CORESET pool index in the first CC, where the second CORESET pool index may be associated with the second cell identifier and a second TAG, transmitting, to the UE, fourth control signaling activating third one or more TCI states associated with a third CORESET pool index for a second CC, where the third CORESET pool index may be associated with a second serving cell identifier and the first TAG, and where the first timing advance offset value may be equal to a third timing advance offset value associated with the third CORESET pool index of the second serving cell identifier, and transmitting, to the UE, fifth control signaling activating fourth one or more TCI states associated with a fourth CORESET pool index for the second CC, where the fourth CORESET pool index may be associated with a third cell identifier of a second set of cell identifiers associated with the second CC and a third TAG.

Some examples of the method, apparatuses, and non-transitory computer-readable medium described herein may further include operations, features, means, or instructions for transmitting, to the UE, second control signaling activating first one or more TCI states for a first CORESET pool index for the first CC, where the first CORESET pool index may be associated with the first serving cell identifier and a first TAG, transmitting, to the UE, third control signaling activating second one or more TCI states for a second CORESET pool index for the first CC, where the second CORESET pool index may be associated with the second cell identifier and a second TAG, transmitting, to the UE, fourth control signaling activating third one or more TCI states associated with a third CORESET pool index for a second CC, where the third CORESET pool index may be associated with a third cell identifier of a second set of cell identifiers associated with the second CC and the second TAG, and where the first timing advance offset value may be equal to a third timing advance offset value associated with the third cell identifier of the second set of cell identifiers, and transmitting, to the UE, fifth control signaling activating fourth one or more TCI states associated with a fourth CORESET pool index for the second CC, where the fourth CORESET pool index may be associated with a second serving cell identifier and a third TAG.

Some examples of the method, apparatuses, and non-transitory computer-readable medium described herein may further include operations, features, means, or instructions for transmitting, to the UE, second control signaling activating first one or more TCI states for a first CORESET pool index for the first CC, where the first CORESET pool index may be associated with the second cell identifier and a first TAG, transmitting, to the UE, third control signaling activating second one or more TCI states for a second CORESET pool index for the first CC, where the second CORESET pool index may be associated with the first serving cell identifier and a second TAG, transmitting, to the UE, fourth control signaling activating third one or more TCI states associated with a third CORESET pool index for a second CC, where the third CORESET pool index may be associated with a third cell identifier of a second set of cell identifiers associated with the second CC and a third TAG, and transmitting, to the UE, fifth control signaling activating fourth one or more TCI states associated with a fourth CORESET pool index for the second CC, where the fourth CORESET pool index may be associated with a second serving cell identifier and the first TAG, and where the second timing advance offset value may be equal to a third timing advance offset value associated with the second serving cell identifier.

Some examples of the method, apparatuses, and non-transitory computer-readable medium described herein may further include operations, features, means, or instructions for transmitting, to the UE, second control signaling activating first one or more TCI states for a first CORESET pool index for the first CC, where the first CORESET pool index may be associated with the first serving cell identifier and a first TAG, transmitting, to the UE, third control signaling activating second one or more TCI state for a second CORESET pool index for the first CC, where the second CORESET pool index may be associated with the second cell identifier and a second TAG, transmitting, to the UE, fourth control signaling activating third one or more TCI states associated with a third CORESET pool index for a second CC, where the third CORESET pool index may be associated with a second serving cell identifier and a third TAG, and transmitting, to the UE, fifth control signaling activating fourth one or more TCI states associated with a fourth CORESET pool index for the second CC, where the fourth CORESET pool index may be associated with a third cell identifier of a second set of cell identifiers associated with the second CC and the second TAG, and where the second timing advance offset value may be equal to a third timing advance offset value associated with the third cell identifier.

### BRIEF DESCRIPTION OF THE DRAWINGS

FIG. 1 illustrates an example of a wireless communications system that supports timing advance offset configuration for inter-cell multiple downlink control information (multi-DCI) multiple transmission and reception point (multi-TRP) operation in accordance with one or more aspects of the present disclosure.

FIG. 2 illustrates an example of a network architecture that supports timing advance offset configuration for inter-cell multi DCI (mDCI) multi TRP (mTRP) operation in accordance with one or more aspects of the present disclosure.

FIG. 3 illustrates an example of a wireless communications system that supports timing advance offset configuration for inter-cell mDCI mTRP operation in accordance with one or more aspects of the present disclosure.

FIG. 4 illustrates an example of a timing diagram that supports timing advance offset configuration for inter-cell mDCI mTRP operation in accordance with one or more aspects of the present disclosure.

FIG. 5 illustrates an example of a timing diagram that supports timing advance offset configuration for inter-cell mDCI mTRP operation in accordance with one or more aspects of the present disclosure.

FIG. 6 illustrates an example of a process flow that supports timing advance offset configuration for inter-cell mDCI mTRP operation in accordance with one or more aspects of the present disclosure.

FIGS. 7 and 8 show block diagrams of devices that support timing advance offset configuration for inter-cell mDCI mTRP operation in accordance with one or more aspects of the present disclosure.

FIG. 9 shows a block diagram of a communications manager that supports timing advance offset configuration for inter-cell mDCI mTRP operation in accordance with one or more aspects of the present disclosure.

FIG. 10 shows a diagram of a system including a device that supports timing advance offset configuration for inter-cell mDCI mTRP operation in accordance with one or more aspects of the present disclosure.

FIGS. 11 and 12 show block diagrams of devices that support timing advance offset configuration for inter-cell mDCI mTRP operation in accordance with one or more aspects of the present disclosure.

FIG. 13 shows a block diagram of a communications manager that supports timing advance offset configuration for inter-cell mDCI mTRP operation in accordance with one or more aspects of the present disclosure.

FIG. 14 shows a diagram of a system including a device that supports timing advance offset configuration for inter-cell mDCI mTRP operation in accordance with one or more aspects of the present disclosure.

FIGS. 15 through 20 show flowcharts illustrating methods that support timing advance offset configuration for inter-cell mDCI mTRP operation in accordance with one or more aspects of the present disclosure.

### DETAILED DESCRIPTION

In some wireless communications systems, a user equipment (UE) may receive downlink control information (DCI) from multiple transmission and reception points (TRP) s to schedule uplink transmissions (e.g., physical uplink shared channel (PUSCH) transmissions) to the multiple TRPs. The UE may differentiate the TRPs based on control resource set (CORESET) pool indices associated with the TRPs. The UE may adjust the timing of an uplink transmission by applying a timing advance value to the uplink transmission. By applying the timing advance value, the timing of an uplink transmission may be “advanced” by an amount indicated by a timing advance value. The timing advance value may be based on a timing advance offset value. Timing advance offset values may depend on the cell associated with the uplink transmission. One or two timing advance offset values may be configured per serving cell. When two CORESET pool indices are configured for a serving cell, however, additional physical cell identifiers (PCI) s may be configured for the serving cell. When the network changes a transmission configuration indicator (TCI) state for a given CORESET pool index, the PCI associated with the CORESET pool index (and therefore the TRP) also changes. When the PCI for a CORESET pool index changes, the timing advance offset to apply to uplink transmissions for the CORESET pool index may also change. The one or two timing advance offset values configured per serving cell, however, may be insufficient to support the additional PCIs configured for the serving cell, which may each be associated with a different timing advance offset.

Accordingly, a timing advance offset value associated with each additional PCI for a serving cell may be indicated. The network may indicate, for example, via a radio resource control (RRC) message, a configuration for a serving cell that includes one or two timing advance offset values for the serving cell identifier and respective timing advance offset values associated with each additional PCI for the serving cell. Each PCI may be associated with a TCI state. Accordingly, the UE may apply the appropriate timing advance offset value for given uplink transmissions based on the TCI state (and therefore the PCI) associated with the given uplink transmissions. Each PCI may be associated with a timing advance group (TAG). For example, two TAGs may be configured per component carrier (CC). A same TAG may apply to CORESET pool indices in different CCs. Across different CCs, uplink transmissions associated with the same TAG apply the same timing advance offset value. Accordingly, across different CCs, the activated PCIs that share a same TAG share a same timing advance offset value.

Aspects of the disclosure are initially described in the context of wireless communications systems. Aspects of the disclosure are further illustrated by and described with reference to timing diagrams and process flows. Aspects of the disclosure are further illustrated by and described with reference to apparatus diagrams, system diagrams, and flowcharts that relate to timing advance offset configuration for inter-cell multi DCI (mDCI) multi TRP (mTRP) operation.

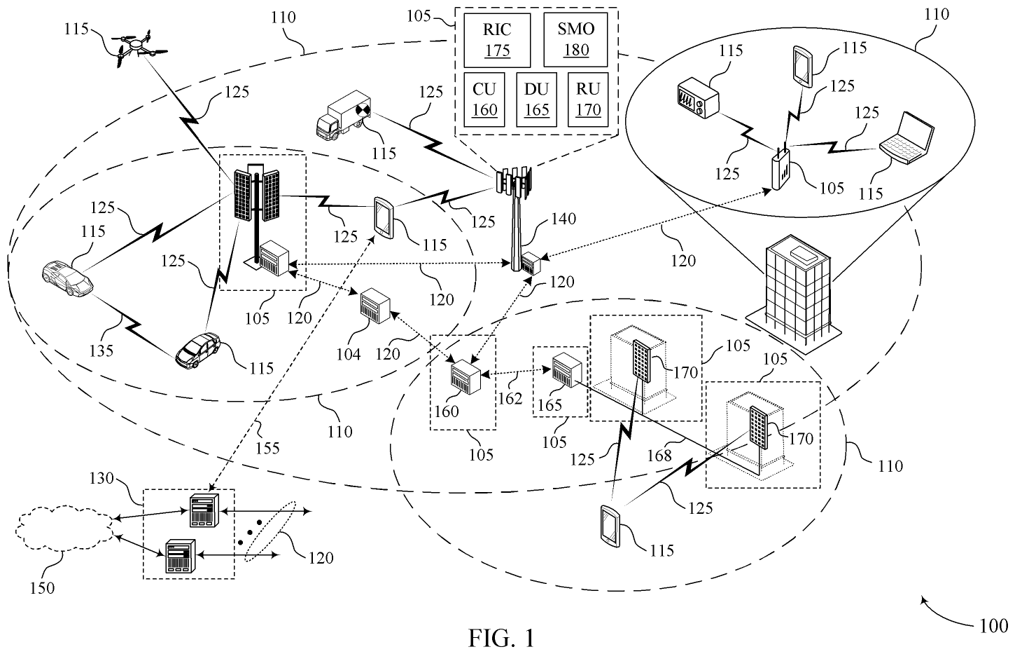

FIG. 1 illustrates an example of a wireless communications system 100 that supports timing advance offset configuration for inter-cell mDCI mTRP operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support timing advance offset configuration for inter-cell mDCI mTRP operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a given carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a PCI, a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell, for example, covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along given orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a given orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a given receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a UE 115 may receive DCI from multiple TRPs to schedule uplink transmissions (e.g., PUSCH transmissions) to the multiple TRPs. The UE 115 may differentiate the TRPs based on CORESET pool indices associated with the TRPs. The UE 115 may adjust the timing of an uplink transmission by applying a timing advance value to the uplink transmission. By applying the timing advance value, the timing of an uplink transmission may be “advanced” by an amount indicated by a timing advance value. The timing advance value may be based on a timing advance offset value. Timing advance offset values may depend on the cell associated with the uplink transmission. One or two timing advance offset values may be configured per serving cell for a CC. Additional PCIs may be configured for the serving cell. When the network changes a TCI state for a given CORESET pool index, the PCI associated with the CORESET pool index (and therefore the TRP) also changes. When the PCI for a CORESET pool index changes, the timing advance offset to apply to uplink transmissions for the CORESET pool index may also change.

Accordingly, a timing advance offset value associated with each additional PCI for a serving cell may be indicated by the network to the UE 115. A network entity 105 may indicate, for example, via an RRC message, a configuration for a serving cell that includes one or two timing advance offset values for the serving cell PCI and respective timing advance offset values associated with each additional PCI for the serving cell. Each PCI may be associated with a TCI state. Accordingly, the UE may apply the appropriate timing advance offset value for given uplink transmissions based on the TCI state (and therefore the PCI) associated with the given uplink transmissions. Each PCI may be associated with a TAG. For example, two TAGs may be configured per CC. A same TAG may apply to CORESET pool indices in different CCs. Across different CCs, uplink transmissions associated with the same TAG apply the same timing advance offset value. Accordingly, across different CCs, the activated PCIs that share a same TAG share a same timing advance offset value.

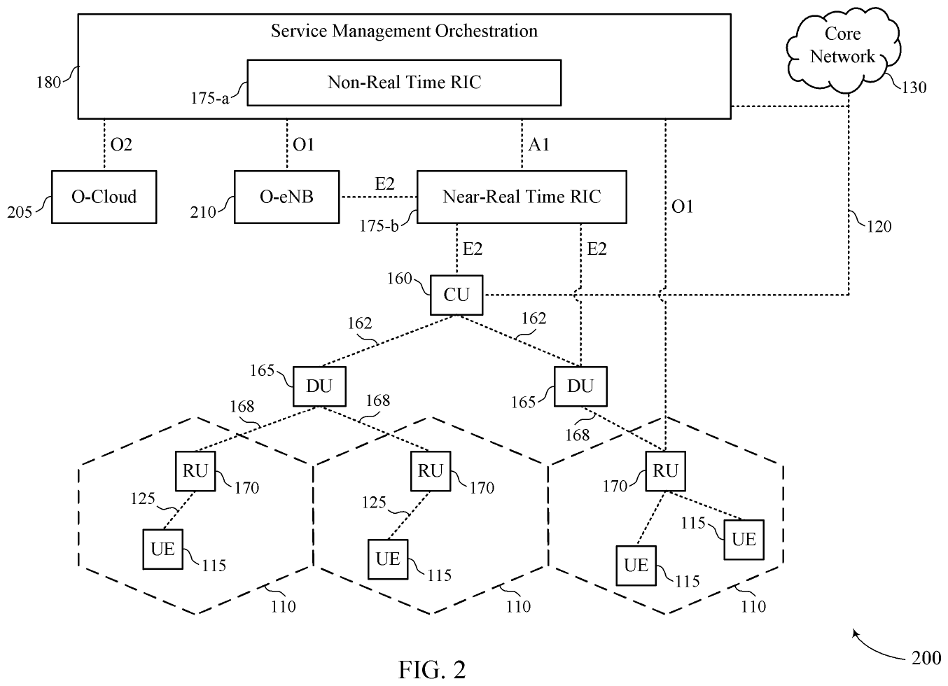

FIG. 2 illustrates an example of a network architecture 200 (e.g., a disaggregated base station architecture, a disaggregated RAN architecture) that supports timing advance offset configuration for inter-cell mDCI mTRP operation in accordance with one or more aspects of the present disclosure. The network architecture 200 may illustrate an example for implementing one or more aspects of the wireless communications system 100. The network architecture 200 may include one or more CUs 160 that may communicate directly with a core network 130 via a backhaul communication link 120, or indirectly with the core network 130 through one or more disaggregated network entities 105 (e.g., a Near-RT RIC 175-b via an E2 link, or a Non-RT RIC 175-a associated with an SMO 180 (e.g., an SMO Framework), or both). A CU 160 may communicate with one or more DUs 165 via respective midhaul communication links 162 (e.g., an F1 interface). The DUs 165 may communicate with one or more RUs 170 via respective fronthaul communication links 168. The RUs 170 may be associated with respective coverage areas 110 and may communicate with UEs 115 via one or more communication links 125. In some implementations, a UE 115 may be simultaneously served by multiple RUs 170.

Each of the network entities 105 of the network architecture 200 (e.g., CUs 160, DUs 165, RUs 170, Non-RT RICs 175-a, Near-RT RICs 175-b, SMOs 180, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160 may host one or more higher layer control functions. Such control functions may include RRC, PDCP, SDAP, or the like. Each control function may be implemented with an interface configured to communicate signals with other control functions hosted by the CU 160. A CU 160 may be configured to handle user plane functionality (e.g., CU-UP), control plane functionality (e.g., CU-CP), or a combination thereof. In some examples, a CU 160 may be logically split into one or more CU-UP units and one or more CU-CP units. A CU-UP unit may communicate bidirectionally with the CU-CP unit via an interface, such as an E1 interface when implemented in an O-RAN configuration. A CU 160 may be implemented to communicate with a DU 165, as necessary, for network control and signaling.

A DU 165 may correspond to a logical unit that includes one or more functions (e.g., base station functions, RAN functions) to control the operation of one or more RUs 170. In some examples, a DU 165 may host, at least partially, one or more of an RLC layer, a MAC layer, and one or more aspects of a PHY layer (e.g., a high PHY layer, such as components for FEC encoding and decoding, scrambling, modulation and demodulation, or the like) depending, at least in part, on a functional split, such as those defined by the 3rd Generation Partnership Project (3GPP). In some examples, a DU 165 may further host one or more low PHY layers. Each layer may be implemented with an interface configured to communicate signals with other layers hosted by the DU 165, or with control functions hosted by a CU 160.

In some examples, lower-layer functionality may be implemented by one or more RUs 170. For example, an RU 170, controlled by a DU 165, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170 may be implemented to handle over the air (OTA) communication with one or more UEs 115. In some implementations, real-time and non-real-time aspects of control and user plane communication with the RU(s) 170 may be controlled by the corresponding DU 165. In some examples, such a configuration may enable a DU 165 and a CU 160 to be implemented in a cloud-based RAN architecture, such as a vRAN architecture.

The SMO 180 may be configured to support RAN deployment and provisioning of non-virtualized and virtualized network entities 105. For non-virtualized network entities 105, the SMO 180 may be configured to support the deployment of dedicated physical resources for RAN coverage requirements which may be managed via an operations and maintenance interface (e.g., an O1 interface). For virtualized network entities 105, the SMO 180 may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160, DUs 165, RUs 170, and Near-RT RICs 175-b. In some implementations, the SMO 180 may communicate with components configured in accordance with a 4G RAN (e.g., via an O1 interface). Additionally, or alternatively, in some implementations, the SMO 180 may communicate directly with one or more RUs 170 via an O1 interface. The SMO 180 also may include a Non-RT RIC 175-a configured to support functionality of the SMO 180.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160, one or more DUs 165, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180 or the Non-RT RIC 175-a from non-network data sources or from network functions. In some examples, the Non-RT RIC-a 175 or the Near-RT RIC 175-b may be configured to tune RAN behavior or performance. For example, the Non-RT RIC 175-a may monitor long-term trends and patterns for performance and employ AI or ML models to perform corrective actions through the SMO 180 (e.g., reconfiguration via O1) or via generation of RAN management policies (e.g., A1 policies).

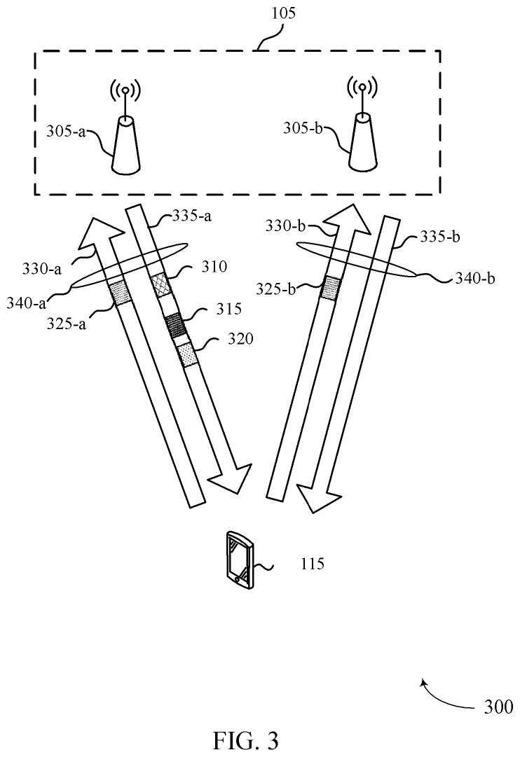

FIG. 3 illustrates an example of a wireless communications system 300 that supports timing advance offset configuration for inter-cell mDCI mTRP operation in accordance with one or more aspects of the present disclosure. The wireless communications system 300 may include a UE 115 and a network entity 105.

The UE 115 may operate in a multiple TRP mode with a first TRP 305-a and a second TRP 305-b. In some implementations, the first TRP 305-a and the second TRP 305-b may be located at a same network entity 105. In some implementations, the first TRP 305-a and the second TRP 305-b may be located at different network entities.

The UE 115 may communicate with the first TRP 305-a and the second TRP 305-b. In some implementations, the UE 115 may be capable of communicating simultaneously with the first TRP 305-a and the second TRP 305-b (such as using a same set of time resources, or a same set of frequency resource, or both, but different spatial resources). The UE 115 may communicate with the first TRP 305-a using a communication link 340-a. The UE 115 may communicate with the second TRP 305-b using a communication link 340-b. The communication link 340-a and the communication link 340-b may include bi-directional links that enable both uplink and downlink communication. For example, the UE 115 may transmit uplink signals 330-a, such as uplink control signals or uplink data signals, to the first TRP 305-a using the communication link 340-a and the first TRP 305-a may transmit downlink signals 335-a, such as downlink control signals or downlink data signals, to the UE 115 using the communication link 340-a. The UE 115 may transmit uplink signals 330-b, such as uplink control signals or uplink data signals, to the second TRP 305-b using the communication link 340-b and the second TRP 305-b may transmit downlink signals 335-b, such as downlink control signals or downlink data signals, to the UE 115 using the communication link 340-b. In some implementations, different TRPs (such as the first TRP 305-a and the second TRP 305-b) may have different TRP identifiers. In some implementations, different TRPs may be identified through an association with other identifiers, such as a CORESET pool index, closed loop index, TCI identifier, TCI group identifier, or a sounding reference signal resource set identifier.

The UE 115 may support mDCI based mTRP transmission operations. In a mDCI based mTRP operation, a first DCI message (transmitted from the first TRP 305-a) may schedule a first physical downlink shared channel (PDSCH) transmitted from the first TRP 305-a via the communication link 340-a, and a second DCI message (transmitted from the second TRP 305-b) may schedule a second PDSCH transmitted from the second TRP 305-b via the communication link 340-b. TRP differentiation at the UE side may be associated with a CORESET pool index. Each CORESET (e.g., of a maximum 5 CORESETs) may be configured with a value of the parameter CORESETPoolIndex, which may be “0” or “1”. Accordingly, CORESETs may be grouped into two groups. Aside from the CORESET pool index, the TRPs (the first TRP 305-a and the second TRP 305-b) may be transparent to the UE 115. The UE 115 may be configured with multi-DCI based multi-TRP operation in a given CC.

In some implementations, a UE may be configured by the higher layer parameter PDCCH-Config that includes two different values of the parameter CORESETPoolIndex in CORESETs for the active BWP of the serving cell. For example, the CORESETPoolIndex “0” may include a CORESET identifier equal to “1” and a CORESET identifier equal to “2,” and the CORESETPoolIndex “1” may include a CORESET identifier equal to “3” and a CORESET identifier equal to “4.” The CORESETPoolIndex of the CORESET in which a DCI is received may be used for different purposes, for example HARQ feedback.

In some examples, different TRPs may have the same PCI (e.g., the TRPs may be intra-cell). For example, intra-cell TRPs may be different antenna panels of the same cell, different RRHs of the same cell, or at the same base station. In some examples, different TRPs may have different PCIs (e.g., inter-cell). In inter-cell TRP cases, from the perspective of the UE 115, the multi-TRP configuration is defined in a given serving cell, but the UE 115 may be aware of one PCI. The one PCI may be the PCI the UE 115 acquired during a cell search.

The UE 115 may receive an RRC message 310 configuring a list of up to M candidate TCI states for the purpose of quasi co-location (QCL) indication. For example, M may equal 128. The M candidate TCI states may be configured in an RRC field PDSCH-Config. The RRC field TCI-StateID may be used for configuring the TCI states for a CORESET, a non-zero power CSI reference signal (CSI-RS), physical uplink control channel (PUCCH) resources, or sounding reference signals. In some examples, the network may transmit a MAC control element (MAC-CE) 315 to activate up to 2^{N} TCI states out of M for PDSCH QCL indication for a given CORESET pool index. In some examples, for a physical downlink control channel (PDCCH), the network may transmit a MAC-CE 315 to activate one TCI state. In some examples, the network may transmit a DCI message 320 that may include N bits that may dynamically indicate the TCI state for a PDSCH transmission scheduled by the DCI message 320. For example, N may equal 3. In some examples, for multi-DCI based multi-TRP, the PDSCH may be associated with the CORESET pool index value of the CORESET in which the DCI message 320 is received. The UE 115 may use different beams to receive different synchronization signal blocks (SSB)s. QCL information may indicate which beam to use for a given communication (e.g., transmission or reception of a signal) based on indicating an associated SSB. For example, an SSB may be associated with the serving cell for the UE 115.

The RRC field PDSCH-Config may include parameters tci-StatesToAddModList and tci-StatesToReleaseList that indicate a list of TCI states indicating a transmission configuration which includes a QCL relationship between downlink reference signals (e.g., SSBs) and PDSCH demodulation reference signal (DMRS) ports. The RRC field PDSCH-Config may include a CORESET pool index identifier, which may indicate a TRP to the UE 115. For example, table 1 shows an example association between a serving cell ID, a CORESET pool index, and configured TCI states (e.g., T₀, T₁, . . . , T_{(n-2)×8+7}).

TABLE 1

| CORESET pool | | | | | | | |
|---|---|---|---|---|---|---|---|
| index ID | Serving Cell ID | | | | | BWP ID | |
| T₇ | T₆ | T₅ | T₄ | T₃ | T₂ | T₁ | T₀ |
| T₁₆ | T₁₅ | T₁₄ | T₁₃ | T₁₂ | T₁₁ | T₁₀ | T₉ |

. . .

| | | | | | | | |
|---|---|---|---|---|---|---|---|
| T_{(n-2)×8+7} | T_{(n-2)×8+6} | T_{(n-2)×8+5} | T_{(n-2)×8+4} | T_{(n-2)×8+3} | T_{(n-2)×8+2} | T_{(n-2)×8+1} | T_{(n-2)×8} |

In some examples, in inter-cell mTRP operations, a maximum number of additional RRC configured PCIs per CC may be denoted X, and may be reported to the UE 115 by the network (e.g., in the RRC message 310). In some examples, the network may support two independent X values (X1, X2), which may be reported as a UE capability for two different assumptions based on additional SSB time domain position and periodicity and with respect to the serving cell SSB. X1 (e.g., case 1) may be equal to the maximum number of configured additional PCIs when each configuration of SSB time domain positions and periodicity of the additional PCIs is the same as the SSB time domain positions and periodicity of the serving cell PCI. X2 (e.g., case 2) may be equal to the number of configured additional PCIs when the configurations of SSB time domain positions and periodicity of the additional PCIs is not according to case 1. Accordingly case 1 and case 2 may not be enabled simultaneously. The UE capability may differentiate between frequency range (FR) 1 and FR2. The center frequency, the subcarrier spacing (SCS), and the SFN offset may be assumed to be the same for SSBs from the serving cell and the configured SSBs with PCIs different from the serving cell for inter-cell mTRP operation. In some cases, a field in the RRC message may indicate non-serving cell information that a TCI state or QCL information is associated with a given non-serving cell. The field may not indicate an exact PCI value.

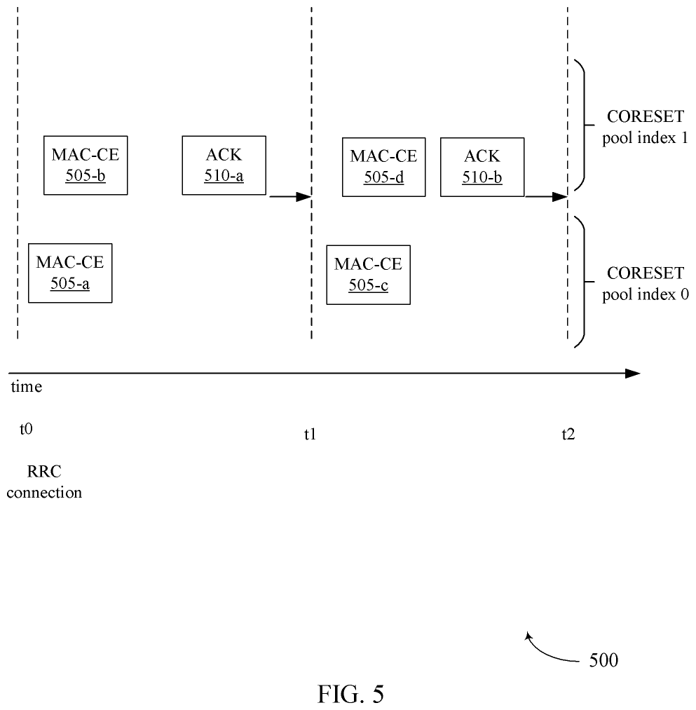

A field ServingCellConfig in the RRC message 310 may indicate the SSB and TCI state associated with the serving cell for a CC. The field ServingCellConfig may also indicate one or more additional PCIs (e.g., one or more PCI indices) for the CC, the SSB associated with, and the corresponding QCL information or TCI state for the PCI. As described with reference to FIG. 5, a serving cell PCI for a CC may be associated with an active TCI state, and one additional PCI may be associated with an active TCI state for the CC. For inter-cell mTRP, one PCI associated with one or more of the activated TCI states for a PDSCH or PDCCH may be associated with one CORESET pool index (e.g., TRP), and another PCI associated with one or more of the activated TCI states for a PDSCH or PDCCH may be associated with another CORESET pool index (e.g., TRP).

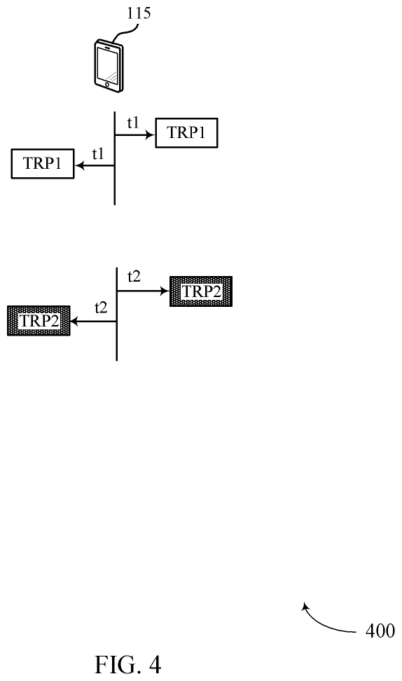

The UE 115 may transmit uplink transmissions (e.g., a first uplink transmission 325-a to the first TRP 305-a and a second uplink transmission 325-b to the second TRP 305-b) in accordance with a timing advance associated with each TRP. An uplink frame number i for transmission from a UE 115 may start at T_{TA}=(N_{TA}+N_{TA,offset})T_{c} with respect to a downlink frame. N_{TA} may be acquired by the UE in a random access response (RAR) message from a cell. For a msgA of a random access channel (RACH) procedure, N_{TA}=0 may be used. N_{TA,offset} may be indicated in the RRC message 310. For example, the field n-TimingAdvanceOffset in the RRC message 310 may indicate the N_{TA,offset} for the serving cell. If the UE 115 is not indicated a N_{TA,offset} for the serving cell, the UE 115 may apply a default value for N_{TA,offset} for the serving cell (e.g., 25600 for FR1 band). In the case of multiple uplink carriers (e.g., CCs) in the same TAG, the UE 115 may expect the same value of n-TimingAdvanceOffset to be provided for all of the uplink carriers. As described with reference to FIG. 4, two timing advances for uplink mDCI mTRP operation may be specified, for example different TRPs (e.g., the first TRP 305-a and the second TRP 305-b) may have different timing advance values. To support two timing advance values for mDCI mTRP operation, multiple TAG identifiers (ID)s may be configured for a serving cell if the serving cell is configured with two CORESET pool index values.

In some examples, one n-TimingAdvanceOffset value may be configured in RRC (e.g., the RRC message 310) per serving cell. In some examples, two n-TimingAdvanceOffset values may be configured in RRC (e.g., the RRC message 310) per serving cell. For inter-cell mDCI mTRP operation (e.g., if two CORESET pool index values are configured for a serving cell and multiple additional PCIs are configured for the serving cell), the additional PCI associated with a given CORESET pool index may change if the one or more active TCI states associated with the CORESET pool index value is updated by a MAC-CE (e.g., the MAC-CE 315). When the additional PCI associated with the given CORESET pool index value changes, the n-TimingAdvanceOffset value for that given CORESETPoolIndex value may change. Accordingly, one or two n-TimingAdvanceOffset may not be able to support additional PCIs (e.g., up to 7) that may be configured per CC.

Accordingly, an n-TimingAdvanceOffset value may be configured per additional PCI. For a serving cell, the n-TimingAdvanceOffset (or two n-TimingAdvanceOffset values) may be configured in the RRC field ServingCellConfigCommon. In some examples, the n-TimingAdvanceOffset value for additional PCIs may be configured in the field ServingCellConfigCommon. For example, each n-TimingAdvanceOffset value may be associated with an additional PCI index. For different UEs, the same additional PCI index may be associated with different PCIs. For example, the network may indicate for each UE an association between PCI indices and PCIs (e.g., in RRC). Accordingly, the network may ensure that the PCIs across different UEs associated with the same PCI index may have the same n-TimingAdvanceOffset value. In another example, the n-TimingAdvanceOffset value for additional PCIs may be configured in the RRC field ServingCellConfig. For example, n-TimingAdvanceOffset configuration for the additional PCIs may be a UE dedicated configuration (e.g., dedicated for the UE 115).

As described herein, for uplink CCs associated with the same TAG, the UE 115 expects the same n-TimingAdvanceOffset value for all uplink CCs in the TAG. Accordingly, if at least one CC is configured with two TAGs and multiple additional PCIs, and each additional PCI in the at least one CC is configured with an n-TimingAdvanceOffset value, the condition that the UE 115 expects the same n-TimingAdvanceOffset value for all uplink CCs associated with the same TAG may be applied when configuring the n-TimingAdvanceOffset values for the additional PCIs across the multiple CCs.

Each PCI may be configured with a TAG ID. Table 2 shows an example where a CC (e.g., CC1) is configured with two TAGs (e.g., TAG 1 and TAG 2) and multiple additional PCIs (e.g., PCI 1, PCI 2, PCI3). For example, CC1 shown in Table 2 may be configured as an inter-cell mDCI TRP operation.

TABLE 2

| | PCI | TAG ID | n-TimingAdvanceOffset |
|---|---|---|---|
| CC1 (inter-cell | Serving cell PCI | TAG 1 | n-TimingAdvanceOffset 0 |
| mDCI mTRP) | Additional PCI 1 | TAG 1 | n-TimingAdvanceOffset 1 |
| | Additional PCI 2 | TAG 2 | n-TimingAdvaceOffset 3 |
| | Additional PCI 3 | TAG 2 | n-TimingAdvanceOffset 2 |

Table 3 shows a case where a second CC (e.g., CC2) is configured with a single CORESET pool index value or is not configured with a CORESET pool index. Accordingly, Table 3 shows CC2 configured in a single TRP operation. The UE 115 may expect the PCIs that are associated with a common TAG (e.g., TAG1 or TAG 2) in the at least one CC (e.g., CC1 as shown in Table 2) and the serving cell PCI in the other CC (CC2 as shown in Table 3) to be configured with the same n-TimingAdvance Offset value. Accordingly, in the RRC message 310, n-TimingAdvanceOffset 0′ in Table 3 is equal to n-TimingAdvanceOffset 1 in Table 2 which is equal to n-TimingAdvanceOffset 0 in Table 2, as each are associated with TAG 1. In other words the PCIs (e.g., serving cell PCI and additional PCI 1 in Table 2) that are associated with a common TAG (e.g., TAG 1) in the at least one CC (e.g., CC1) and the other CC (e.g., CC2) are configured with the same n-TimingAdvanceOffset value.

TABLE 3

| | PCI | TAG ID | n-TimingAdvanceOffset |
|---|---|---|---|
| CC2 (Single | Serving cell PCI | TAG 1 | n-TimingAdvanceOffset 0′ |
| TRP) | | | |

Table 4 shows a case where the other CC (e.g., CC2) is configured with one or both TAGs of the two TAGs (e.g., TAG 1 or TAG 2 or both TAG1 and TAG2). The CC2 as shown in Table 3 may be configured with two CORESET pool index value but is not configured with additional PCIs. Accordingly, Table 4 shows the other CC (e.g., CC2) configured as an intra-cell mDCI TRP operation. For each of the one or both TAGs, the UE 115 expects that the PCIs associated with one of the one or two TAGs in the at least one CC (e.g., CC1) and the serving cell PCI that is associated with the same one of the one or two TAGs in the other CC (e.g., CC2) to be configured with the same n-TimingAdvanceOffset value. In other words, the PCIs that are associated with one of the one or both TAGs in the at least one CC (e.g., CC1) are configured with the same n-TimingAdvanceOffset value. Accordingly, in the RRC message 310, n-TimingAdvanceOffset 0′ in Table 4 is equal to n-TimingAdvanceOffset 1 in Table 2 which is equal to n-TimingAdvanceOffset 0 in Table 2, as each are associated with TAG 1. Similarly, n-TimingAdvanceOffset 1′ in Table 4 is equal to n-TimingAdvanceOffset 2 in Table 2 which is equal to n-TimingAdvanceOffset 3 in Table 2, as each are associated with TAG 2.

TABLE 4

| | PCI | TAG ID | n-TimingAdvanceOffset |
|---|---|---|---|
| CC2 (intra-cell | Serving cell PCI | TAG 1 | n-TimingAdvanceOffset 0′ |
| mDCI TRP) | Serving cell PCI | TAG 2 | n-TimingAdvanceOffset 1′ |

Table 5 shows a case where the other CC (e.g., CC2) is configured with two CORESET pool index values and is configured with additional PCIs. For each of the one or both TAGs (e.g., TAG 1 and TAG 2), the UE 115 expects that the PCIs (e.g., the serving cell PCIs or additional PCIs) that are associated with one of the one or two TAGs in the at least one CC (e.g., CC1) and the PCIs (e.g., serving cell PCI or the additional PCIs) that are associated with the same one of the one or two TAGs in the other CC to be configured with the same n-TimingAdvanceOffset value. In other words, the PCIs that are associated with one of the one or both TAGs in the at least one CC (e.g., CC1) are configured with the same n-TimingAdvanceOffset value. Accordingly, in the RRC message 310, n-TimingAdvanceOffset 0′ in Table 5 is equal to n-TimingAdvanceOffset 1′ in Table 5 which is equal to n-TimingAdvanceOffset 2 in Table 2 which is equal to n-TimingAdvanceOffset 3 in Table 2, as each are associated with TAG 2.

TABLE 5

| | PCI | TAG ID | n-TimingAdvanceOffset |
|---|---|---|---|
| CC2 (inter-cell | Serving cell PCI | TAG 2 | n-TimingAdvanceOffset 0′ |
| mDCI mTRP) | Additional PCI 1′ | TAG 2 | n-TimingAdvanceOffset 1′ |
| | Additional PCI 2′ | TAG 3 | n-TimingAdvaceOffset 2′ |
| | Additional PCI 3′ | TAG 3 | n-TimingAdvanceOffset 3′ |

Additionally, or alternatively, each additional PCI may be associated with the TAG ID that is associated with the same CORESET pool index value as the additional PCI. For example, Table 6 below shows an example listing of PCIs and associated n-TimingAdvanceOffset values that may be indicated to the UE 115 in the RRC message for a first CC (e.g., CC1) and a second CC (e.g., CC2). Table 7 below indicates potential activated PCIs based on the TAG IDs associated with each CORESET pool index. For example, Table 6 and Table 7 show a case where CC1 is configured as an inter-cell mDCI mTRP operation, and CC2 is configured as a single TRP operation. As shown in Table 6 and Table 7, if the other CC (e.g., CC2) is configured with a single TAG of the two TAGs (e.g., TAG 1 and TAG 2) and is configured with a single CORESET pool index or is not configured with a CORESET pool index (e.g., CC2 is configured in a single TRP operation), when activating one or more TCI states for a CORESET pool index value that is associated with the single TAG (e.g., TAG 2) for the at least one CC (e.g., CC1), the UE 115 expects the additional PCIs associated with the active TCI states in at least one CC (e.g., CC1) have the same n-TimingAdvanceOffset value as the serving cell PCI that is associated with the single TAG in the other CC (CC2). In other words, the activated TCI state for CORESET pool index value 1 in the CC1 may be either the additional PCI 1 or the additional PCI 3, as the CORESET pool index value 1 in CC1 is associated with the TAG 2 and the CORESET pool index value 1 in CC2 is also associated with the TAG 2, and PCI 1, PCI 3, and the serving cell PCI in CC2 each are configured with n-TimingAdvanceOffset 1.

TABLE 6

| | |
|---|---|
| PCI | n-TimingAdvanceOffset |

CC1

| | |
|---|---|
| Serving cell PCI | n-TimingAdvanceOffset 0 |
| Additional PCI 1 | n-TimingAdvanceOffset 1 |
| Additional PCI 2 | n-TimingAdvanceOffset 2 |
| Additional PCI 3 | n-TimingAdvanceOffset 1 |

CC2

| | |
|---|---|
| Serving cell PCI | n-TimingAdvanceOffset 1 |

TABLE 7

| | TRP ID | TAG ID | Activated PCI |
|---|---|---|---|
| CC1 | CORESETPoolIndex | TAG 1 | Serving cell PCI |
| (Inter-cell | value 0 | | |
| mDCI mTRP) | CORESETPoolIndex | TAG 2 | Additional PCI 1 |
| | value 1 | | or PCI 3 |
| CC2 | CORESETPoolIndex | TAG 2 | Serving cell PCI |
| (Single TRP) | value 1 | | |

Table 8 below shows another example listing of PCIs and associated n-TimingAdvanceOffset values that may be indicated to the UE 115 in the RRC message for a first CC (e.g., CC1) and a second CC (e.g., CC2). Table 9 below indicates potential activated PCIs of Table 8 based on the TAG IDs associated with each CORESET pool index. For example, Table 8 and Table 9 show a case where CC1 is configured as an inter-cell mDCI mTRP operation, and CC2 is configured as an intra-cell mDCI TRP operation. As shown in Table 8 and Table 9, if the other CC (e.g., CC2) is configured with two CORESET pool index values but is not configured with additional PCIs, when activating one or more TCI states for a CORESET pool index value that is associated with the one of the one or both TAGs for the at least one CC (e.g., CC1), the UE 115 may expect the PCI (e.g., either the serving cell PCI or additional PCI) associated with the one or more TCI states in the at least one CC (e.g., CC1) has the same n-TimingAdvanceOffset value as the serving cell PCI that is associated with the same one of the one or both TAGs in the other CC (e.g., CC2). For example, the activated PCI for the CORESET pool index value 0 in the first CC1, which is associated with TAG 1, may be any of the serving cell PCI, PCI 1, or PCI 3, which are configured with n-TimingAdvanceOffset 1, as the activated PCI for CORESET pool index value 0 in CC2, which is associated with TAG 1, is the serving cell PCI having n-TimingAdvanceOffset 1. Similarly, the activated PCI for the CORESET pool index value 1 in the first CC1, which is associated with TAG 2, may be any of the serving cell PCI or PCI 2, which are configured with n-TimingAdvanceOffset 2, as the activated PCI for CORESET pool index value 1 in CC2, which is associated with TAG 2, is the serving cell PCI having n-TimingAdvanceOffset 2.

TABLE 8

| | |
|---|---|
| PCI | n-TimingAdvanceOffset |

CC1

| | |
|---|---|
| Serving cell PCI | n-TimingAdvanceOffset 1 |
| Serving cell PCI | n-TimingAdvanceOffset 2 |
| Additional PCI 1 | n-TimingAdvanceOffset 1 |
| Additional PCI 2 | n-TimingAdvanceOffset 2 |
| Additional PCI 3 | n-TimingAdvanceOffset 1 |

CC2

| | |
|---|---|
| Serving cell PCI | n-TimingAdvanceOffset 1 |
| Serving cell PCI | n-TimingAdvanceOffset 2 |

TABLE 9

| | TRP ID | TAG ID | Activated PCI |
|---|---|---|---|
| CC1 | CORESETPoolIndex | TAG 1 | Serving cell PCI or |
| (Inter-cell | value 0 | | additional PCI 1 or |
| mDCI mTRP) | | | additional PCI 3 |
| | CORESETPoolIndex | TAG 2 | Serving cell PCI or |
| | value 1 | | additional PCI 2 |
| CC2 | CORESETPoolIndex | TAG 1 | Serving cell PCI (n- |
| (Intra-cell | value 0 | | TimingAdvanceOffset |
| mDCI TRP) | | | 1) |
| | CORESETPoolIndex | TAG 2 | Serving cell PCI (n- |
| | value 1 | | TimingAdvanceOffset |
| | | | 2) |

Table 10 below shows another example listing of PCIs and associated n-TimingAdvanceOffset values that may be indicated to the UE 115 in the RRC message for a first CC (e.g., CC1) and a second CC (e.g., CC2). Table 11 below indicates potential activated PCIs of Table 10 based on the TAG IDs associated with each CORESET pool index. For example, Table 10 and Table 11 show a case where both CC1 and CC1 are configured as inter-cell mDCI mTRP operations. As shown in Table 10 and Table 11, if the other CC (e.g., CC2) is configured with two CORESET pool index values and with additional PCIs, if a first one or more TCI states are activated for a CORESET pool index value that is associated with one of the one or both TAGs that are associated with the same one of the one or both TAGs for the other CC (e.g., CC2), and a second one or more TCI states are activated for the CORESET pool index that is associated with the same one of the one or both TAGs for the other CC (e.g., CC2), the UE 115 may expect the PCI (e.g., either the serving cell PCI or additional PCI) that is associated with the first one or more TCI states and the PCI that is associated with the second one or more TCI states have the same associated n-TimingAdvanceOffset value.

For example, the activated PCI for the CORESET pool index value 0 for CC1, which is associated with TAG 1, may be the serving cell PCI, the additional PCI 1, or the additional PCI 3, which each have n-TimingAdvanceOffset 1. The activated PCI for the CORESET pool index value 0 for CC2, which is also associated with TAG 1, may be the serving cell PCI, the additional PCI 1′, or the additional PCI 2′, which also each have n-TimingAdvanceOffset 1. As the CORESET pool index value 1 in CC1 and the CORESET pool index value 1 in CC2 do not share a TAG across CCs, any PCI may be activated for the CORESET pool index value 1 in CC1 and the CORESET pool index value 1 in CC2.

TABLE 10

| | |
|---|---|
| PCI | n-TimingAdvanceOffset |

CC1

| | |
|---|---|
| Serving cell PCI | n-TimingAdvanceOffset 1 |
| Serving cell PCI | n-TimingAdvanceOffset 2 |
| Additional PCI 1 | n-TimingAdvanceOffset 1 |
| Additional PCI 2 | n-TimingAdvanceOffset 3 |
| Additional PCI 3 | n-TimingAdvanceOffset 1 |

CC2

| | |
|---|---|
| Serving cell PCI | n-TimingAdvanceOffset 1 |
| Serving cell PCI | n-TimingAdvanceOffset 4 |
| Additional PCI 1′ | n-TimingAdvanceOffset 1 |
| Additional PCI 2′ | n-TimingAdvanceOffset 1 |
| Additional PCI 3′ | n-TimingAdvanceOffset 5 |

TABLE 11

| | TRP ID | TAG ID | Activated PCI |
|---|---|---|---|
| CC1 | CORESETPoolIndex | TAG 1 | Serving cell PCI or |
| (Inter-cell | value 0 | | additional PCI 1 or |
| mDCI mTRP) | | | additional PCI 3 |
| | CORESETPoolIndex | TAG 2 | Any |
| | value 1 | | |
| CC2 | CORESETPoolIndex | TAG 1 | Serving cell PCI (n- |
| (Inter-cell | value 0 | | TimingAdvanceOffset |
| mDCI mTRP) | | | 1) or additional PCI |
| | | | 1′ or additional PCI |
| | | | 2′ |
| | CORESETPoolIndex | TAG 3 | Any |
| | value 1 | | |

FIG. 4 illustrates an example of a timing diagram 400 that supports timing advance offset configuration for inter-cell mDCI mTRP operation in accordance with one or more aspects of the present disclosure. In some implementations, the timing diagram 400 may implement aspects of wireless communications system 100 or the wireless communications system 300. For example, the timing diagram 400 may include a UE 115, which may be an example of a UE 115 as described herein. The TRP1 and TRP2 may be examples of the first TRP 305-a and the second TRP 305-b, as described with reference to FIG. 3.

In some implementations, separate uplink timing may be applied for a multi-TRP deployment, where a first timing advance value (such as t1) is applied for communications between the UE 115 and the TRP 1, and a second timing advance value (such as t2) is applied for communications between the UE 115 and the TRP2. Accordingly, two timing advances may be specified, and each TRP (the TRP1 and the TRP2) may have different timing advance values (such as specified via TAG values).

FIG. 5 illustrates an example of a timing diagram 500 that supports timing advance offset configuration for inter-cell mDCI mTRP operation in accordance with one or more aspects of the present disclosure. In some implementations, the timing diagram 400 may implement aspects of or be implemented by aspects of the wireless communications system 100 or the wireless communications system 300.

At a time t0, a UE 115 may receive establish an RRC connection with the network (e.g., may receive an RRC message) for a CC. The RRC message may configure two CORESET pool indices for the CC, CORESET pool index 0 and CORESET pool index 1. The RRC message may configure a TCI state list. Each TCI state in the list may be associated with a PCI (e.g., either a serving cell PCI or an additional PCI). For example, the RRC may indicate TCI states associated with a serving cell PCI, a first additional PCI (e.g., additional PCI 1), and a second additional PCI (e.g., additional PCI 2). The UE 115 may receive a MAC-CE 505-a for the CORESET pool index 0 that activates one or more TCI states associated with the serving cell PCI. The UE 115 may receive a MAC-CE 505-b for the CORESET pool index 1 that activates one or more TCI states associated with an additional PCI (e.g., additional PCI 1) The UE 115 may transmit an acknowledgment 510-a in response to receiving the MAC-CE 505-a and the MAC-CE 505-b. In some case, the UE may transmit separate acknowledgment in response to receiving MAC CE 505-a and the MAC-CE 505-b, although this is not shown in FIG. 5. Accordingly, at a time t1 the TCI state associated with the serving cell may be activated for the CORESET pool index 0 (e.g., for PDCCH/PDSCH) and the TCI state associated with additional PCI 1 may be activated for the CORESET pool index 1 (e.g., for PDCCH/PDSCH).

After t1, the UE 115 may receive a MAC-CE 505-c for the CORESET pool index 0 that activates the TCI state associated with the serving cell PCI. The UE 115 may receive a MAC-CE 505-d for the CORESET pool index 1 that activates a different TCI state associated with a different additional PCI (e.g., additional PCI 2) The UE 115 may transmit an acknowledgment 510-b in response to receiving the MAC-CE 505-c and the MAC-CE 505-d. In some case, the UE may transmit separate acknowledgment in response to receiving MAC CE 505-c and 505-d, although this is not shown in FIG. 5. Accordingly, at a time t2 the TCI state associated with the serving cell may be activated for the CORESET pool index 0 (e.g., for PDCCH/PDSCH) and the TCI state associated with additional PCI 2 may be activated for the CORESET pool index 1 (e.g., for PDCCH/PDSCH).

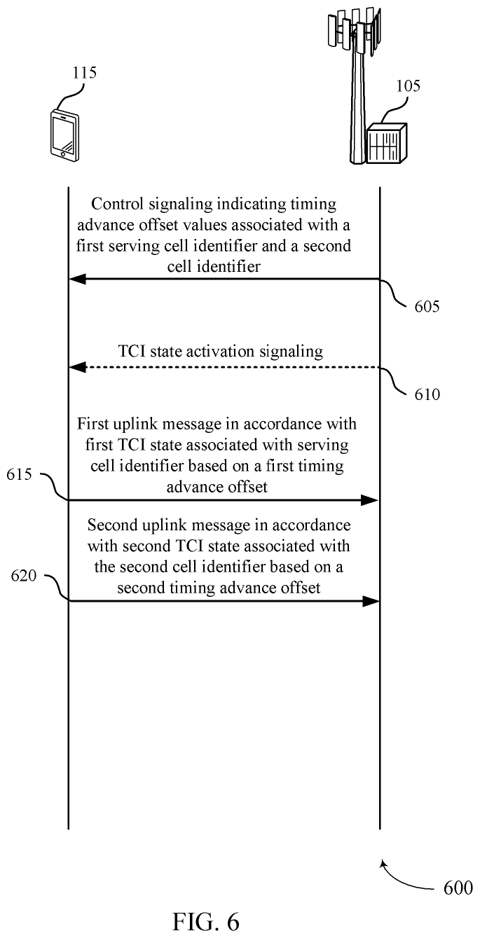

FIG. 6 illustrates an example of a process flow 600 that supports timing advance offset configuration for inter-cell mDCI mTRP operation in accordance with one or more aspects of the present disclosure. The process flow 600 may include a network entity 105, which may be an example of a network entity 105 as described herein. In the following description of the process flow 600, the operations between the network entity 105 and the UE 115 may be transmitted in a different order than the example order shown, or the operations performed by the network entity 105 and the UE 115 may be performed in different orders or at different times. Some operations also may be omitted from the process flow 600, and other operations may be added to the process flow 600.

At 605, the UE 115 may receive, from the network entity 105, control signaling indicating a first timing advance offset value associated with a first serving cell identifier and a second timing advance offset value associated with a second cell identifier of a set of cell identifiers, where the first serving cell identifier and the second cell identifier are associated with a first CC.

In some examples, receiving the control signaling includes receiving the control signaling including a field indicating an association between the second cell identifier and the second timing advance offset value. For example, the control signaling may be an RRC message.

In some examples, receiving the control signaling includes: receiving the control signaling including one or more fields indicating an association between a set of cell identifier indices and a set of timing advance offset values, the set of cell identifier indices common to a set of UEs associated with the first serving cell identifier; and receiving an indication of an association between the set of cell identifiers and the set of cell identifier indices.

In some examples, receiving the control signaling includes: receiving the control signaling indicating the first CC is associated with a first TAG and a second TAG, where the first timing advance offset value, the second timing advance offset value, and additional timing advance offset values associated with the set of cell identifiers are each associated with one of the first TAG or the second TAG; and receiving the control signaling indicating a second CC associated with the first TAG and a third timing advance offset value associated with the second CC, where the third timing advance offset value is associated with the first TAG, and where timing advance offset values associated with the first TAG in the first CC and the second CC are equal.

In some examples, receiving the control signaling includes: receiving the control signaling indicating the first CC associated with a first TAG and a second TAG, where the first timing advance offset value, the second timing advance offset value, and additional timing advance offset values associated with the set of cell identifiers are each associated with one of the first TAG or the second TAG; and receiving the control signaling indicating a second CC associated with at least one of the first TAG or the second TAG and a third timing advance offset value associated with the second CC, where the third timing advance offset value is associated with the at least one of the first TAG or the second TAG, and where timing advance offset values associated with the at least one of the first TAG or the second TAG in the first CC and the second CC are equal.

In some examples, receiving the control signaling includes: receiving the control signaling indicating the first CC is associated with a first TAG and a second TAG, where the first timing advance offset value, the second timing advance offset value, and additional timing advance offset values associated with the set of cell identifiers are each associated with one of the first TAG, the second TAG, or a third TAG; and receiving the control signaling indicating a second set of cell identifiers associated with a second CC, the second CC associated with at least one of the first TAG or the second TAG and a second set of timing advance offset values associated with the second set of cell identifiers, where a subset of timing advance offset values of the second set of timing advance offset values are associated with the at least one of the first TAG or the second TAG, and where timing advance offset values associated with the at least one of the first TAG or the second TAG in the first CC and the second CC are equal.

In some examples, at 610, the UE 115 may receive, from the network entity 105, control signaling activating a first TCI state associated with the first serving cell identifier and a second TCI state associated with the second cell identifier. For example, the control signaling activating TCI states may be one or more MAC-CEs.

In some examples, receiving the control signaling at 610 may include: receiving second control signaling activating first one or more TCI states for a first CORESET pool index in the first CC, where the first CORESET pool index is associated with the first serving cell identifier and a first TAG; receiving third control signaling activating second one or more TCI states for a second CORESET pool index in the first CC, where the second CORESET pool index is associated with the second cell identifier and a second TAG; and receiving fourth control signaling activating third one or more TCI states associated with a second serving cell identifier for a second CC, where the second serving cell identifier is associated with the second TAG, and where the second timing advance offset value is equal to a third timing advance offset value associated with the second serving cell identifier.

In some examples, receiving the control signaling at 610 may include: receiving second control signaling activating first one or more TCI states for a first CORESET pool index in the first CC, where the first CORESET pool index is associated with the first serving cell identifier and a first TAG; receiving third control signaling activating second one or more TCI states for a second CORESET pool index in the first CC, where the second CORESET pool index is associated with the second cell identifier and a second TAG; receiving fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier; and receiving fifth control signaling activating fourth one or more TCI states associated with a fourth CORESET pool index for the second CC, where the fourth CORESET pool index is associated with the second serving cell identifier and the second TAG, and where the second timing advance offset value is equal to a fourth timing advance offset value associated with the fourth CORESET pool index of the second serving cell identifier.

In some examples, receiving the control signaling at 610 may include: receiving second control signaling activating first one or more TCI states for a first CORESET pool index in the first CC, where the first CORESET pool index is associated with the first serving cell identifier and a first TAG; receiving third control signaling activating second one or more TCI states for a second CORESET pool index in the first CC, where the second CORESET pool index is associated with the second cell identifier and a second TAG; receiving fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier; and receiving fifth control signaling activating fourth one or more TCI states associated with a fourth CORESET pool index for the second CC, where the fourth CORESET pool index is associated with a third cell identifier of a second set of cell identifiers associated with the second CC and a third TAG

In some examples, receiving the control signaling at 610 may include: receiving second control signaling activating first one or more TCI states for a first CORESET pool index for the first CC, where the first CORESET pool index is associated with the first serving cell identifier and a first TAG; receiving third control signaling activating second one or more TCI states for a second CORESET pool index for the first CC, where the second CORESET pool index is associated with the second cell identifier and a second TAG; receiving fourth control signaling activating third one or more TCI states associated with a third CORESET pool index for a second CC, where the third CORESET pool index is associated with a third cell identifier of a second set of cell identifiers associated with the second CC and the second TAG, and where the first timing advance offset value is equal to a third timing advance offset value associated with the third cell identifier of the second set of cell identifiers; and receiving fifth control signaling activating fourth one or more TCI states associated with a fourth CORESET pool index for the second CC, where the fourth CORESET pool index is associated with a second serving cell identifier and a third TAG.

In some examples, receiving the control signaling at 610 may include: receiving second control signaling activating first one or more TCI states for a first CORESET pool index for the first CC, where the first CORESET pool index is associated with the second cell identifier and a first TAG; receiving third control signaling activating second one or more TCI states for a second CORESET pool index for the first CC, where the second CORESET pool index is associated with the first serving cell identifier and a second TAG; receiving fourth control signaling activating third one or more TCI states associated with a third CORESET pool index for a second CC, where the third CORESET pool index is associated with a third cell identifier of a second set of cell identifiers associated with the second CC and a third TAG; and receiving fifth control signaling activating fourth one or more TCI states associated with a fourth CORESET pool index for the second CC, where the fourth CORESET pool index is associated with a second serving cell identifier and the first TAG, and where the second timing advance offset value is equal to a third timing advance offset value associated with the second serving cell identifier.

In some examples, receiving the control signaling at 610 may include: receiving second control signaling activating first one or more TCI states for a first CORESET pool index for the first CC, where the first CORESET pool index is associated with the first serving cell identifier and a first TAG; receiving third control signaling activating second one or more TCI state for a second CORESET pool index for the first CC, where the second CORESET pool index is associated with the second cell identifier and a second TAG; receiving fourth control signaling activating third one or more TCI states associated with a third CORESET pool index for a second CC, where the third CORESET pool index is associated with a second serving cell identifier and a third TAG; and receiving fifth control signaling activating fourth one or more TCI states associated with a fourth CORESET pool index for the second CC, where the fourth CORESET pool index is associated with a third cell identifier of a second set of cell identifiers associated with the second CC and the second TAG, and where the second timing advance offset value is equal to a third timing advance offset value associated with the third cell identifier.

At 615, the UE 115 may transmit, and the network entity 105 may receive, a first uplink message in accordance with a first TCI state associated with the first serving cell identifier and based on the first timing advance offset value.

At 620, the UE 115 may transmit, and the network entity 105 may receive, a second uplink message in accordance with a second TCI state associated with the second cell identifier and based on the second timing advance offset.

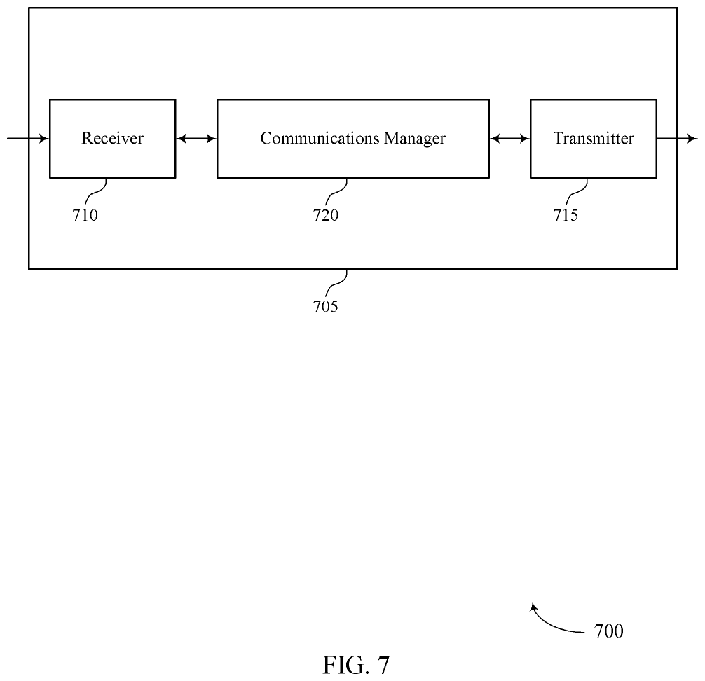

FIG. 7 shows a block diagram 700 of a device 705 that supports timing advance offset configuration for inter-cell mDCI mTRP operation in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to timing advance offset configuration for inter-cell mDCI mTRP operation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to timing advance offset configuration for inter-cell mDCI mTRP operation). In some examples, the transmitter 715 may be co-located with a receiver 710 in a transceiver component. The transmitter 715 may utilize a single antenna or a set of multiple antennas.

The communications manager 720, the receiver 710, the transmitter 715, or various combinations thereof or various components thereof may be examples of means for performing various aspects of timing advance offset configuration for inter-cell mDCI mTRP operation as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The communications manager 720 may be configured as or otherwise support a means for transmitting a first uplink message in accordance with a first TCI state associated with the first serving cell identifier and based on the first timing advance offset value. The communications manager 720 may be configured as or otherwise support a means for transmitting a second uplink message in accordance with a second TCI state associated with the second cell identifier and based on the second timing advance offset.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

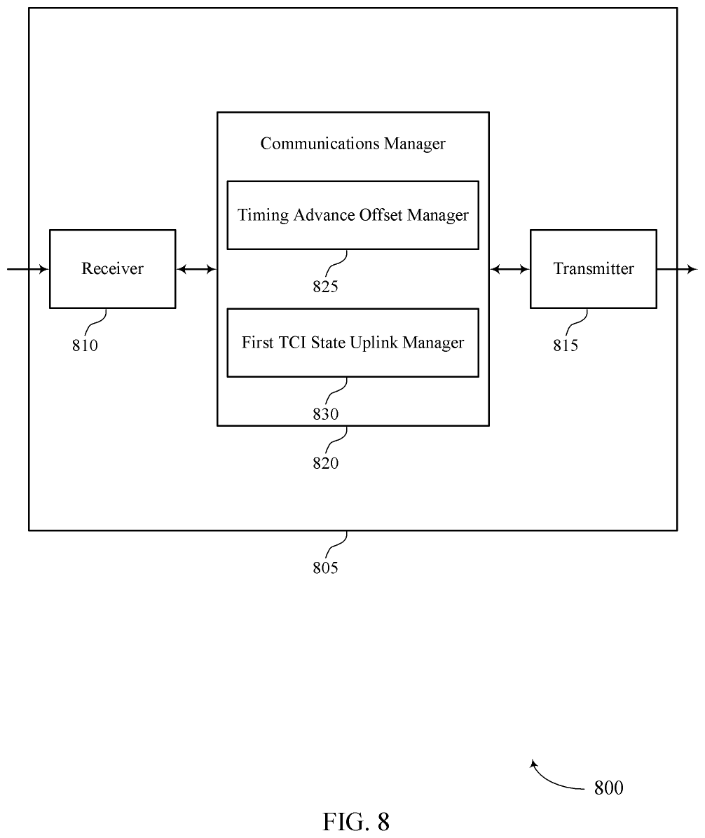

FIG. 8 shows a block diagram 800 of a device 805 that supports timing advance offset configuration for inter-cell mDCI mTRP operation in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to timing advance offset configuration for inter-cell mDCI mTRP operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to timing advance offset configuration for inter-cell mDCI mTRP operation). In some examples, the transmitter 815 may be co-located with a receiver 810 in a transceiver component. The transmitter 815 may utilize a single antenna or a set of multiple antennas.

The device 805, or various components thereof, may be an example of means for performing various aspects of timing advance offset configuration for inter-cell mDCI mTRP operation as described herein. For example, the communications manager 820 may include a timing advance offset manager 825 a first TCI state uplink manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The timing advance offset manager 825 may be configured as or otherwise support a means for receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The first TCI state uplink manager 830 may be configured as or otherwise support a means for transmit a first uplink message in accordance with a first TCI state associated with the first serving cell identifier and based on the first timing advance offset value. The first TCI state uplink manager 830 may be configured as or otherwise support a means for transmit a second uplink message in accordance with a second TCI state associated with the second cell identifier and based on the second timing advance offset.

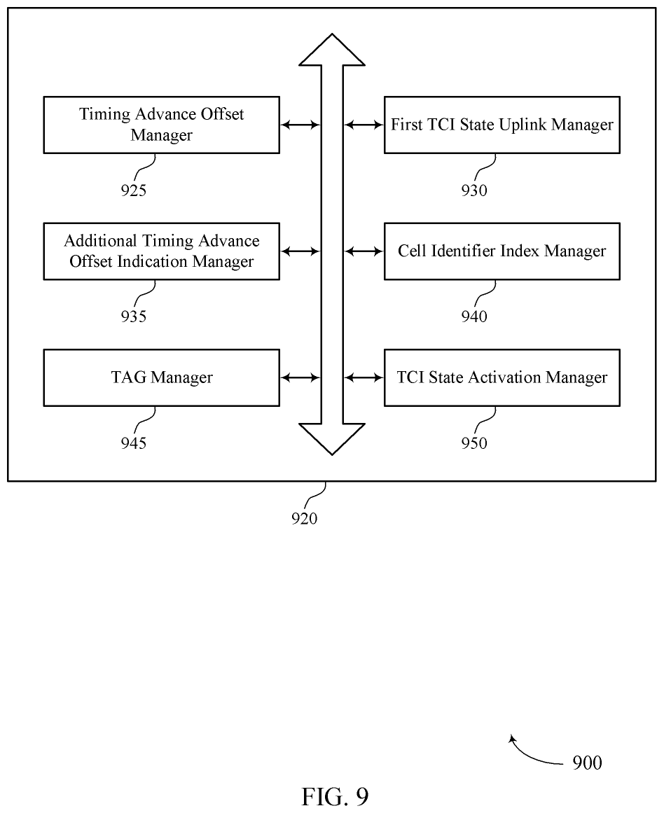

FIG. 9 shows a block diagram 900 of a communications manager 920 that supports timing advance offset configuration for inter-cell mDCI mTRP operation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of timing advance offset configuration for inter-cell mDCI mTRP operation as described herein. For example, the communications manager 920 may include a timing advance offset manager 925, a first TCI state uplink manager 930, an additional timing advance offset indication manager 935, a cell identifier index manager 940, a TAG manager 945, a TCI state activation manager 950, or any combination thereof. Each of these components may communicate, directly or indirectly, with one another (e.g., via one or more buses).

The communications manager 920 may support wireless communications at a UE in accordance with examples as disclosed herein. The timing advance offset manager 925 may be configured as or otherwise support a means for receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The first TCI state uplink manager 930 may be configured as or otherwise support a means for transmit a first uplink message in accordance with a first TCI state associated with the first serving cell identifier and based on the first timing advance offset value. In some examples, the first TCI state uplink manager 930 may be configured as or otherwise support a means for transmit a second uplink message in accordance with a second TCI state associated with the second cell identifier and based on the second timing advance offset.

In some examples, to support receiving the control signaling, the additional timing advance offset indication manager 935 may be configured as or otherwise support a means for receiving the control signaling including a field indicating an association between the second cell identifier and the second timing advance offset value.

In some examples, to support receiving the control signaling, the additional timing advance offset indication manager 935 may be configured as or otherwise support a means for receiving the control signaling including one or more fields indicating an association between a set of cell identifier indices and a set of timing advance offset values, the set of cell identifier indices common to a set of UEs associated with the first serving cell identifier. In some examples, to support receiving the control signaling, the cell identifier index manager 940 may be configured as or otherwise support a means for receiving an indication of an association between the set of cell identifiers and the set of cell identifier indices.

In some examples, to support receiving the control signaling, the TAG manager 945 may be configured as or otherwise support a means for receiving the control signaling indicating the first CC is associated with a first TAG and a second TAG, where the first timing advance offset value, the second timing advance offset value, and additional timing advance offset values associated with the set of cell identifiers are each associated with one of the first TAG or the second TAG. In some examples, to support receiving the control signaling, the TAG manager 945 may be configured as or otherwise support a means for receiving the control signaling indicating a second CC associated with the first TAG and a third timing advance offset value associated with the second CC, where the third timing advance offset value is associated with the first TAG, and where timing advance offset values associated with the first TAG in the first CC and the second CC are equal.

In some examples, to support receiving the control signaling, the TAG manager 945 may be configured as or otherwise support a means for receiving the control signaling indicating the first CC associated with a first TAG and a second TAG, where the first timing advance offset value, the second timing advance offset value, and additional timing advance offset values associated with the set of cell identifiers are each associated with one of the first TAG or the second TAG. In some examples, to support receiving the control signaling, the TAG manager 945 may be configured as or otherwise support a means for receiving the control signaling indicating a second CC associated with at least one of the first TAG or the second TAG and a third timing advance offset value associated with the second CC, where the third timing advance offset value is associated with the at least one of the first TAG or the second TAG, and where timing advance offset values associated with the at least one of the first TAG or the second TAG in the first CC and the second CC are equal.

In some examples, to support receiving the control signaling, the TAG manager 945 may be configured as or otherwise support a means for receiving the control signaling indicating the first CC is associated with a first TAG and a second TAG, where the first timing advance offset value, the second timing advance offset value, and additional timing advance offset values associated with the set of cell identifiers are each associated with one of the first TAG, the second TAG, or a third TAG. In some examples, to support receiving the control signaling, the TAG manager 945 may be configured as or otherwise support a means for receiving the control signaling indicating a second set of cell identifiers associated with a second CC, the second CC associated with at least one of the first TAG or the second TAG and a second set of timing advance offset values associated with the second set of cell identifiers, where a subset of timing advance offset values of the second set of timing advance offset values are associated with the at least one of the first TAG or the second TAG, and where timing advance offset values associated with the at least one of the first TAG or the second TAG in the first CC and the second CC are equal.

In some examples, the TCI state activation manager 950 may be configured as or otherwise support a means for receiving, from the network entity, second control signaling activating first one or more TCI states for a first CORESET pool index in the first CC, where the first CORESET pool index is associated with the first serving cell identifier and a first TAG. In some examples, the TCI state activation manager 950 may be configured as or otherwise support a means for receiving, from the network entity, third control signaling activating second one or more TCI states for a second CORESET pool index in the first CC, where the second CORESET pool index is associated with the second cell identifier and a second TAG. In some examples, the TCI state activation manager 950 may be configured as or otherwise support a means for receiving, from the network entity, fourth control signaling activating third one or more TCI states associated with a second serving cell identifier for a second CC, where the second serving cell identifier is associated with the second TAG, and where the second timing advance offset value is equal to a third timing advance offset value associated with the second serving cell identifier.

In some examples, the TCI state activation manager 950 may be configured as or otherwise support a means for receiving, from the network entity, second control signaling activating first one or more TCI states for a first CORESET pool index in the first CC, where the first CORESET pool index is associated with the first serving cell identifier and a first TAG. In some examples, the TCI state activation manager 950 may be configured as or otherwise support a means for receiving, from the network entity, third control signaling activating second one or more TCI states for a second CORESET pool index in the first CC, where the second CORESET pool index is associated with the second cell identifier and a second TAG. In some examples, the TCI state activation manager 950 may be configured as or otherwise support a means for receiving, from the network entity, fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier. In some examples, the TCI state activation manager 950 may be configured as or otherwise support a means for receiving, from the network entity, fifth control signaling activating fourth one or more TCI states associated with a fourth CORESET pool index for the second CC, where the fourth CORESET pool index is associated with the second serving cell identifier and the second TAG, and where the second timing advance offset value is equal to a fourth timing advance offset value associated with the fourth CORESET pool index of the second serving cell identifier.

In some examples, the TCI state activation manager 950 may be configured as or otherwise support a means for receiving, from the network entity, second control signaling activating first one or more TCI states for a first CORESET pool index in the first CC, where the first CORESET pool index is associated with the first serving cell identifier and a first TAG. In some examples, the TCI state activation manager 950 may be configured as or otherwise support a means for receiving, from the network entity, third control signaling activating second one or more TCI states for a second CORESET pool index in the first CC, where the second CORESET pool index is associated with the second cell identifier and a second TAG. In some examples, the TCI state activation manager 950 may be configured as or otherwise support a means for receiving, from the network entity, fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier. In some examples, the TCI state activation manager 950 may be configured as or otherwise support a means for receiving, from the network entity, fifth control signaling activating fourth one or more TCI states associated with a fourth CORESET pool index for the second CC, where the fourth CORESET pool index is associated with a third cell identifier of a second set of cell identifiers associated with the second CC and a third TAG.

In some examples, the TCI state activation manager 950 may be configured as or otherwise support a means for receiving, from the network entity, second control signaling activating first one or more TCI states for a first CORESET pool index for the first CC, where the first CORESET pool index is associated with the first serving cell identifier and a first TAG. In some examples, the TCI state activation manager 950 may be configured as or otherwise support a means for receiving, from the network entity, third control signaling activating second one or more TCI states for a second CORESET pool index for the first CC, where the second CORESET pool index is associated with the second cell identifier and a second TAG. In some examples, the TCI state activation manager 950 may be configured as or otherwise support a means for receiving, from the network entity, fourth control signaling activating third one or more TCI states associated with a third CORESET pool index for a second CC, where the third CORESET pool index is associated with a third cell identifier of a second set of cell identifiers associated with the second CC and the second TAG, and where the first timing advance offset value is equal to a third timing advance offset value associated with the third cell identifier of the second set of cell identifiers; and. In some examples, the TCI state activation manager 950 may be configured as or otherwise support a means for receiving, from the network entity, fifth control signaling activating fourth one or more TCI states associated with a fourth CORESET pool index for the second CC, where the fourth CORESET pool index is associated with a second serving cell identifier and a third TAG.

In some examples, the TCI state activation manager 950 may be configured as or otherwise support a means for receiving, from the network entity, second control signaling activating first one or more TCI states for a first CORESET pool index for the first CC, where the first CORESET pool index is associated with the second cell identifier and a first TAG. In some examples, the TCI state activation manager 950 may be configured as or otherwise support a means for receiving, from the network entity, third control signaling activating second one or more TCI states for a second CORESET pool index for the first CC, where the second CORESET pool index is associated with the first serving cell identifier and a second TAG. In some examples, the TCI state activation manager 950 may be configured as or otherwise support a means for receiving, from the network entity, fourth control signaling activating third one or more TCI states associated with a third CORESET pool index for a second CC, where the third CORESET pool index is associated with a third cell identifier of a second set of cell identifiers associated with the second CC and a third TAG. In some examples, the TCI state activation manager 950 may be configured as or otherwise support a means for receiving, from the network entity, fifth control signaling activating fourth one or more TCI states associated with a fourth CORESET pool index for the second CC, where the fourth CORESET pool index is associated with a second serving cell identifier and the first TAG, and where the second timing advance offset value is equal to a third timing advance offset value associated with the second serving cell identifier.

In some examples, the TCI state activation manager 950 may be configured as or otherwise support a means for receiving, from the network entity, second control signaling activating first one or more TCI states for a first CORESET pool index for the first CC, where the first CORESET pool index is associated with the first serving cell identifier and a first TAG. In some examples, the TCI state activation manager 950 may be configured as or otherwise support a means for receiving, from the network entity, third control signaling activating second one or more TCI state for a second CORESET pool index for the first CC, where the second CORESET pool index is associated with the second cell identifier and a second TAG. In some examples, the TCI state activation manager 950 may be configured as or otherwise support a means for receiving, from the network entity, fourth control signaling activating third one or more TCI states associated with a third CORESET pool index for a second CC, where the third CORESET pool index is associated with a second serving cell identifier and a third TAG. In some examples, the TCI state activation manager 950 may be configured as or otherwise support a means for receiving, from the network entity, fifth control signaling activating fourth one or more TCI states associated with a fourth CORESET pool index for the second CC, where the fourth CORESET pool index is associated with a third cell identifier of a second set of cell identifiers associated with the second CC and the second TAG, and where the second timing advance offset value is equal to a third timing advance offset value associated with the third cell identifier.

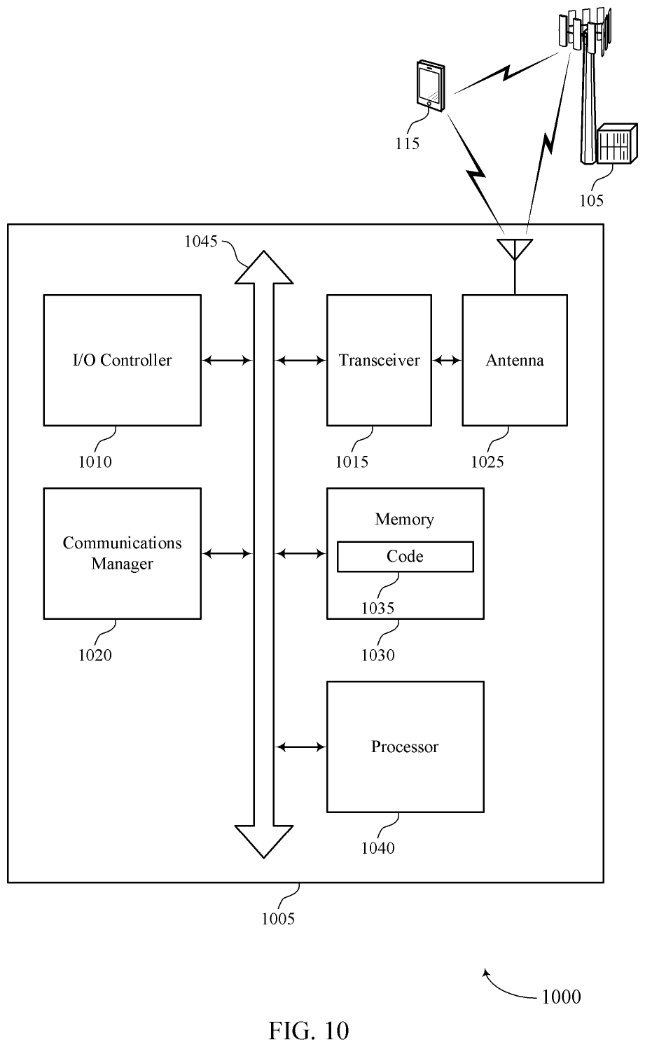

FIG. 10 shows a diagram of a system 1000 including a device 1005 that supports timing advance offset configuration for inter-cell mDCI mTRP operation in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting timing advance offset configuration for inter-cell mDCI mTRP operation). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The communications manager 1020 may be configured as or otherwise support a means for transmitting a first uplink message in accordance with a first TCI state associated with the first serving cell identifier and based on the first timing advance offset value. The communications manager 1020 may be configured as or otherwise support a means for transmitting a second uplink message in accordance with a second TCI state associated with the second cell identifier and based on the second timing advance offset.

By including or configuring the communications manager 1020 in accordance with examples as described herein, the device 1005 may support techniques for more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of timing advance offset configuration for inter-cell mDCI mTRP operation as described herein, or the processor 1040 and the memory 1030 may be otherwise configured to perform or support such operations.

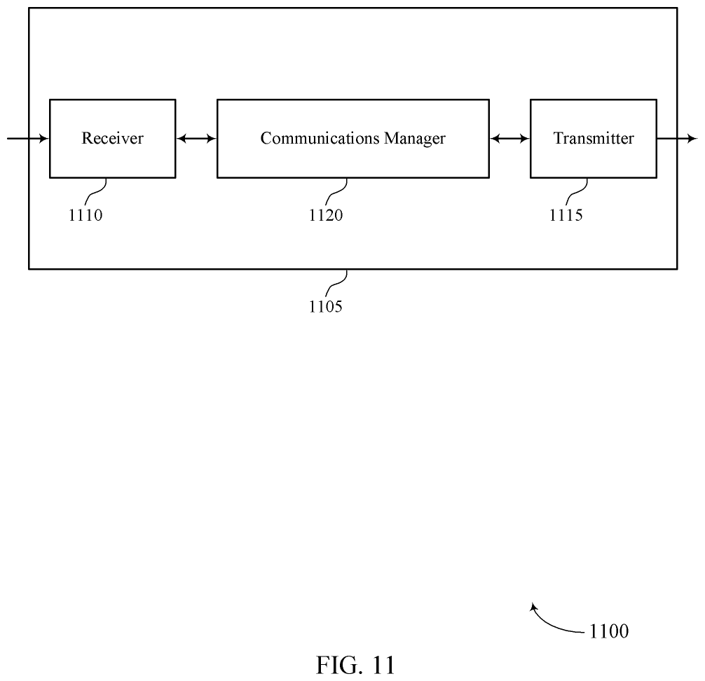

FIG. 11 shows a block diagram 1100 of a device 1105 that supports timing advance offset configuration for inter-cell mDCI mTRP operation in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of timing advance offset configuration for inter-cell mDCI mTRP operation as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The communications manager 1120 may be configured as or otherwise support a means for receiving, from the UE, a first uplink message in accordance with a first TCI state associated with the first serving cell identifier and based on the first timing advance offset value. The communications manager 1120 may be configured as or otherwise support a means for receiving, from the UE, a second uplink message in accordance with a second TCI state associated with the second cell identifier and based on the second timing advance offset.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

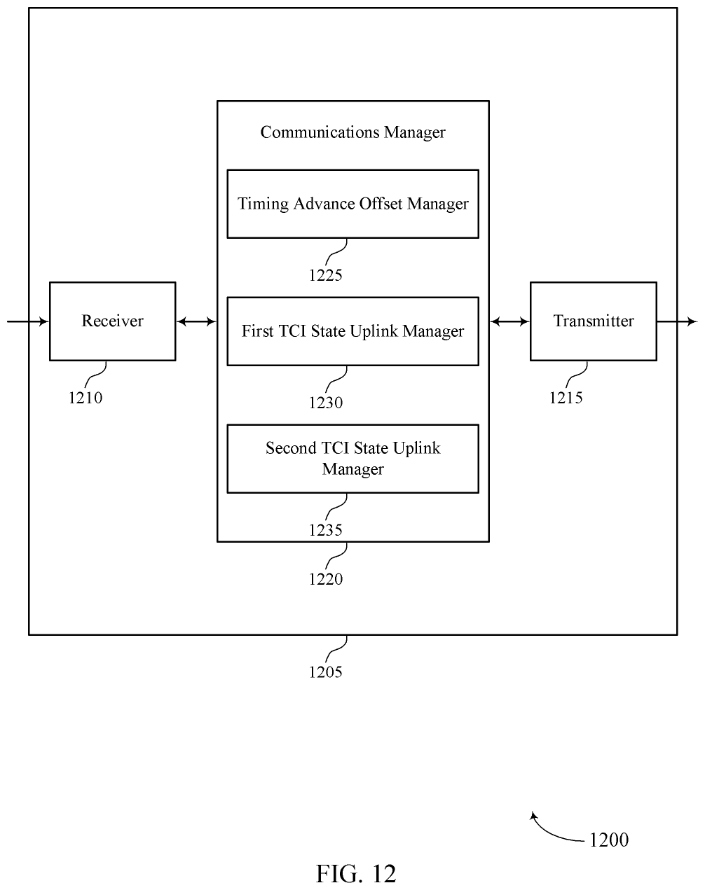

FIG. 12 shows a block diagram 1200 of a device 1205 that supports timing advance offset configuration for inter-cell mDCI mTRP operation in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of timing advance offset configuration for inter-cell mDCI mTRP operation as described herein. For example, the communications manager 1220 may include a timing advance offset manager 1225, a first TCI state uplink manager 1230, a second TCI state uplink manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The timing advance offset manager 1225 may be configured as or otherwise support a means for transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The first TCI state uplink manager 1230 may be configured as or otherwise support a means for receive, from the UE, a first uplink message in accordance with a first TCI state associated with the first serving cell identifier and based on the first timing advance offset value. The second TCI state uplink manager 1235 may be configured as or otherwise support a means for receive, from the UE, a second uplink message in accordance with a second TCI state associated with the second cell identifier and based on the second timing advance offset.

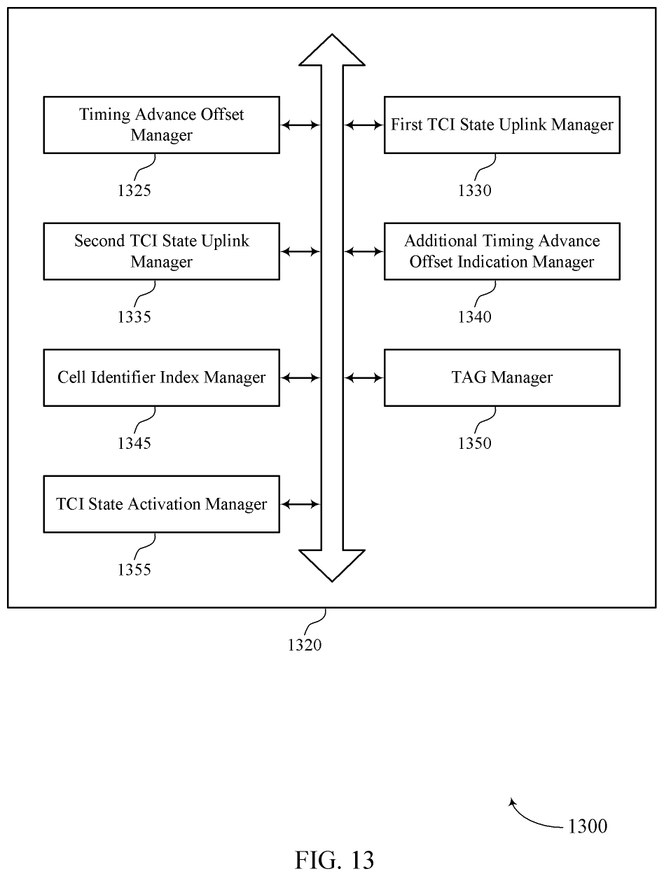

FIG. 13 shows a block diagram 1300 of a communications manager 1320 that supports timing advance offset configuration for inter-cell mDCI mTRP operation in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of timing advance offset configuration for inter-cell mDCI mTRP operation as described herein. For example, the communications manager 1320 may include a timing advance offset manager 1325, a first TCI state uplink manager 1330, a second TCI state uplink manager 1335, an additional timing advance offset indication manager 1340, a cell identifier index manager 1345, a TAG manager 1350, a TCI state activation manager 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The timing advance offset manager 1325 may be configured as or otherwise support a means for transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The first TCI state uplink manager 1330 may be configured as or otherwise support a means for receive, from the UE, a first uplink message in accordance with a first TCI state associated with the first serving cell identifier and based on the first timing advance offset value. The second TCI state uplink manager 1335 may be configured as or otherwise support a means for receive, from the UE, a second uplink message in accordance with a second TCI state associated with the second cell identifier and based on the second timing advance offset.

In some examples, to support transmitting the control signaling, the additional timing advance offset indication manager 1340 may be configured as or otherwise support a means for transmitting the control signaling including a field indicating an association between the second cell identifier and the second timing advance offset value.

In some examples, to support transmitting the control signaling, the additional timing advance offset indication manager 1340 may be configured as or otherwise support a means for transmitting the control signaling including one or more fields indicating an association between a set of cell identifier indices and a set of timing advance offset values, the set of cell identifier indices common to a set of UEs associated with the first serving cell identifier. In some examples, to support transmitting the control signaling, the cell identifier index manager 1345 may be configured as or otherwise support a means for transmitting an indication of an association between the set of cell identifiers and the set of cell identifier indices.

In some examples, to support transmitting the control signaling, the TAG manager 1350 may be configured as or otherwise support a means for transmitting the control signaling indicating the first CC is associated with a first TAG and a second TAG, where the first timing advance offset value, the second timing advance offset value, and additional timing advance offset values associated with the set of cell identifiers are each associated with one of the first TAG or the second TAG. In some examples, to support transmitting the control signaling, the TAG manager 1350 may be configured as or otherwise support a means for transmitting the control signaling indicating a second CC associated with the first TAG and a third timing advance offset value associated with the second CC, where the third timing advance offset value is associated with the first TAG, and where timing advance offset values associated with the first TAG in the first CC and the second CC are equal.

In some examples, to support transmitting the control signaling, the TAG manager 1350 may be configured as or otherwise support a means for transmitting the control signaling indicating the first CC associated with a first TAG and a second TAG, where the first timing advance offset value, the second timing advance offset value, and additional timing advance offset values associated with the set of cell identifiers are each associated with one of the first TAG or the second TAG. In some examples, to support transmitting the control signaling, the TAG manager 1350 may be configured as or otherwise support a means for transmitting the control signaling indicating a second CC associated with at least one of the first TAG or the second TAG and a third timing advance offset value associated with the second CC, where the third timing advance offset value is associated with the at least one of the first TAG or the second TAG, and where timing advance offset values associated with the at least one of the first TAG or the second TAG in the first CC and the second CC are equal.

In some examples, to support transmitting the control signaling, the TAG manager 1350 may be configured as or otherwise support a means for transmitting the control signaling indicating the first CC is associated with a first TAG and a second TAG, where the first timing advance offset value, the second timing advance offset value, and additional timing advance offset values associated with the set of cell identifiers are each associated with one of the first TAG, the second TAG, or a third TAG. In some examples, to support transmitting the control signaling, the TAG manager 1350 may be configured as or otherwise support a means for transmitting the control signaling indicating a second set of cell identifiers associated with a second CC, the second CC associated with at least one of the first TAG or the second TAG and a second set of timing advance offset values associated with the second set of cell identifiers, where a subset of timing advance offset values of the second set of timing advance offset values are associated with the at least one of the first TAG or the second TAG, and where timing advance offset values associated with the at least one of the first TAG or the second TAG in the first CC and the second CC are equal.

In some examples, the TCI state activation manager 1355 may be configured as or otherwise support a means for transmitting, to the UE, second control signaling activating first one or more TCI states for a first CORESET pool index in the first CC, where the first CORESET pool index is associated with the first serving cell identifier and a first TAG. In some examples, the TCI state activation manager 1355 may be configured as or otherwise support a means for transmitting, to the UE, third control signaling activating second one or more TCI states for a second CORESET pool index in the first CC, where the second CORESET pool index is associated with the second cell identifier and a second TAG. In some examples, the TCI state activation manager 1355 may be configured as or otherwise support a means for transmitting, to the UE, fourth control signaling activating third one or more TCI states associated with a second serving cell identifier for a second CC, where the second serving cell identifier is associated with the second TAG, and where the second timing advance offset value is equal to a third timing advance offset value associated with the second serving cell identifier.

In some examples, the TCI state activation manager 1355 may be configured as or otherwise support a means for transmitting, to the UE, second control signaling activating first one or more TCI states for a first CORESET pool index in the first CC, where the first CORESET pool index is associated with the first serving cell identifier and a first TAG. In some examples, the TCI state activation manager 1355 may be configured as or otherwise support a means for transmitting, to the UE, third control signaling activating second one or more TCI states for a second CORESET pool index in the first CC, where the second CORESET pool index is associated with the second cell identifier and a second TAG. In some examples, the TCI state activation manager 1355 may be configured as or otherwise support a means for transmitting, to the UE, fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier. In some examples, the TCI state activation manager 1355 may be configured as or otherwise support a means for transmitting, to the UE, fifth control signaling activating fourth one or more TCI states associated with a fourth CORESET pool index for the second CC, where the fourth CORESET pool index is associated with the second serving cell identifier and the second TAG, and where the second timing advance offset value is equal to a fourth timing advance offset value associated with the fourth CORESET pool index of the second serving cell identifier.

In some examples, the TCI state activation manager 1355 may be configured as or otherwise support a means for transmitting, to the UE, second control signaling activating first one or more TCI states for a first CORESET pool index in the first CC, where the first CORESET pool index is associated with the first serving cell identifier and a first TAG. In some examples, the TCI state activation manager 1355 may be configured as or otherwise support a means for transmitting, to the UE, third control signaling activating second one or more TCI states for a second CORESET pool index in the first CC, where the second CORESET pool index is associated with the second cell identifier and a second TAG. In some examples, the TCI state activation manager 1355 may be configured as or otherwise support a means for transmitting, to the UE, fourth control signaling activating third one or more TCI states associated with a third CORESET pool index for a second CC, where the third CORESET pool index is associated with a second serving cell identifier and the first TAG, and where the first timing advance offset value is equal to a third timing advance offset value associated with the third CORESET pool index of the second serving cell identifier. In some examples, the TCI state activation manager 1355 may be configured as or otherwise support a means for transmitting, to the UE, fifth control signaling activating fourth one or more TCI states associated with a fourth CORESET pool index for the second CC, where the fourth CORESET pool index is associated with a third cell identifier of a second set of cell identifiers associated with the second CC and a third TAG.

In some examples, the TCI state activation manager 1355 may be configured as or otherwise support a means for transmitting, to the UE, second control signaling activating first one or more TCI states for a first CORESET pool index for the first CC, where the first CORESET pool index is associated with the first serving cell identifier and a first TAG. In some examples, the TCI state activation manager 1355 may be configured as or otherwise support a means for transmitting, to the UE, third control signaling activating second one or more TCI states for a second CORESET pool index for the first CC, where the second CORESET pool index is associated with the second cell identifier and a second TAG. In some examples, the TCI state activation manager 1355 may be configured as or otherwise support a means for transmitting, to the UE, fourth control signaling activating third one or more TCI states associated with a third CORESET pool index for a second CC, where the third CORESET pool index is associated with a third cell identifier of a second set of cell identifiers associated with the second CC and the second TAG, and where the first timing advance offset value is equal to a third timing advance offset value associated with the third cell identifier of the second set of cell identifiers. In some examples, the TCI state activation manager 1355 may be configured as or otherwise support a means for transmitting, to the UE, fifth control signaling activating fourth one or more TCI states associated with a fourth CORESET pool index for the second CC, where the fourth CORESET pool index is associated with a second serving cell identifier and a third TAG.

In some examples, the TCI state activation manager 1355 may be configured as or otherwise support a means for transmitting, to the UE, second control signaling activating first one or more TCI states for a first CORESET pool index for the first CC, where the first CORESET pool index is associated with the second cell identifier and a first TAG. In some examples, the TCI state activation manager 1355 may be configured as or otherwise support a means for transmitting, to the UE, third control signaling activating second one or more TCI states for a second CORESET pool index for the first CC, where the second CORESET pool index is associated with the first serving cell identifier and a second TAG. In some examples, the TCI state activation manager 1355 may be configured as or otherwise support a means for transmitting, to the UE, fourth control signaling activating third one or more TCI states associated with a third CORESET pool index for a second CC, where the third CORESET pool index is associated with a third cell identifier of a second set of cell identifiers associated with the second CC and a third TAG. In some examples, the TCI state activation manager 1355 may be configured as or otherwise support a means for transmitting, to the UE, fifth control signaling activating fourth one or more TCI states associated with a fourth CORESET pool index for the second CC, where the fourth CORESET pool index is associated with a second serving cell identifier and the first TAG, and where the second timing advance offset value is equal to a third timing advance offset value associated with the second serving cell identifier.

In some examples, the TCI state activation manager 1355 may be configured as or otherwise support a means for transmitting, to the UE, second control signaling activating first one or more TCI states for a first CORESET pool index for the first CC, where the first CORESET pool index is associated with the first serving cell identifier and a first TAG. In some examples, the TCI state activation manager 1355 may be configured as or otherwise support a means for transmitting, to the UE, third control signaling activating second one or more TCI state for a second CORESET pool index for the first CC, where the second CORESET pool index is associated with the second cell identifier and a second TAG. In some examples, the TCI state activation manager 1355 may be configured as or otherwise support a means for transmitting, to the UE, fourth control signaling activating third one or more TCI states associated with a third CORESET pool index for a second CC, where the third CORESET pool index is associated with a second serving cell identifier and a third TAG. In some examples, the TCI state activation manager 1355 may be configured as or otherwise support a means for transmitting, to the UE, fifth control signaling activating fourth one or more TCI states associated with a fourth CORESET pool index for the second CC, where the fourth CORESET pool index is associated with a third cell identifier of a second set of cell identifiers associated with the second CC and the second TAG, and where the second timing advance offset value is equal to a third timing advance offset value associated with the third cell identifier.

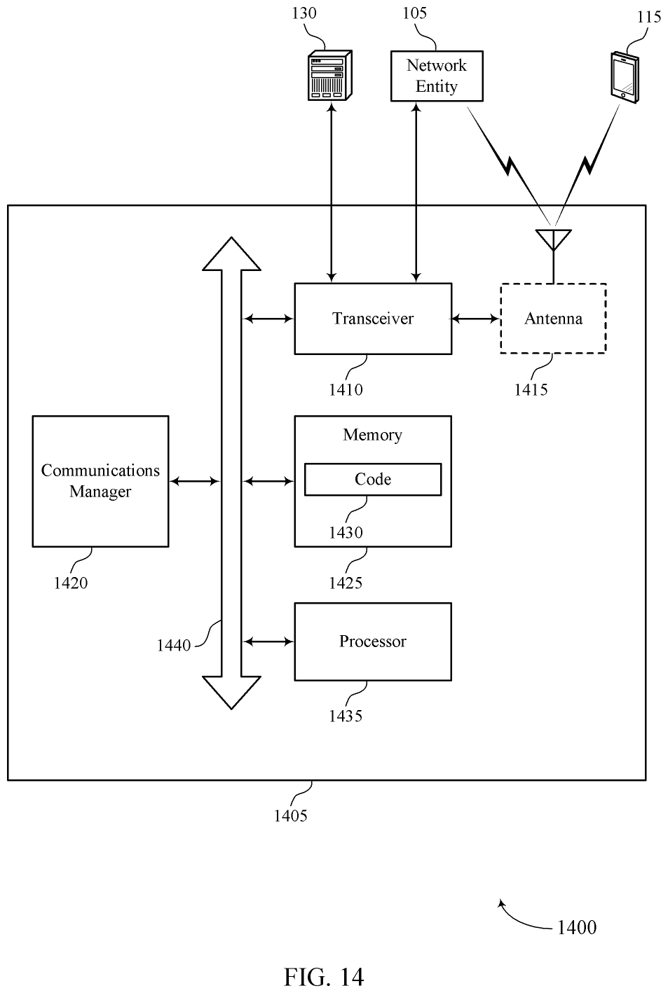

FIG. 14 shows a diagram of a system 1400 including a device 1405 that supports timing advance offset configuration for inter-cell mDCI mTRP operation in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting timing advance offset configuration for inter-cell mDCI mTRP operation). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may, for example, refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The communications manager 1420 may be configured as or otherwise support a means for receiving, from the UE, a first uplink message in accordance with a first TCI state associated with the first serving cell identifier and based on the first timing advance offset value. The communications manager 1420 may be configured as or otherwise support a means for receiving, from the UE, a second uplink message in accordance with a second TCI state associated with the second cell identifier and based on the second timing advance offset.

By including or configuring the communications manager 1420 in accordance with examples as described herein, the device 1405 may support techniques for more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of timing advance offset configuration for inter-cell mDCI mTRP operation as described herein, or the processor 1435 and the memory 1425 may be otherwise configured to perform or support such operations.

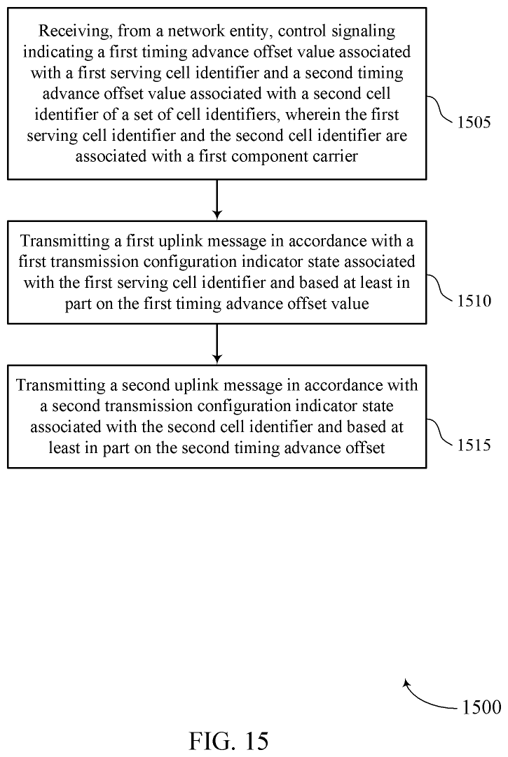

FIG. 15 shows a flowchart illustrating a method 1500 that supports timing advance offset configuration for inter-cell mDCI mTRP operation in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 1505 may be performed in accordance with examples as disclosed herein. In some examples, aspects of the operations of 1505 may be performed by a timing advance offset manager 925 as described with reference to FIG. 9.

At 1510, the method may include transmit a first uplink message in accordance with a first TCI state associated with the first serving cell identifier and based on the first timing advance offset value. The operations of 1510 may be performed in accordance with examples as disclosed herein. In some examples, aspects of the operations of 1510 may be performed by a first TCI state uplink manager 930 as described with reference to FIG. 9.

At 1515, the method may include transmit a second uplink message in accordance with a second TCI state associated with the second cell identifier and based on the second timing advance offset. The operations of 1515 may be performed in accordance with examples as disclosed herein. In some examples, aspects of the operations of 1515 may be performed by a first TCI state uplink manager 930 as described with reference to FIG. 9.

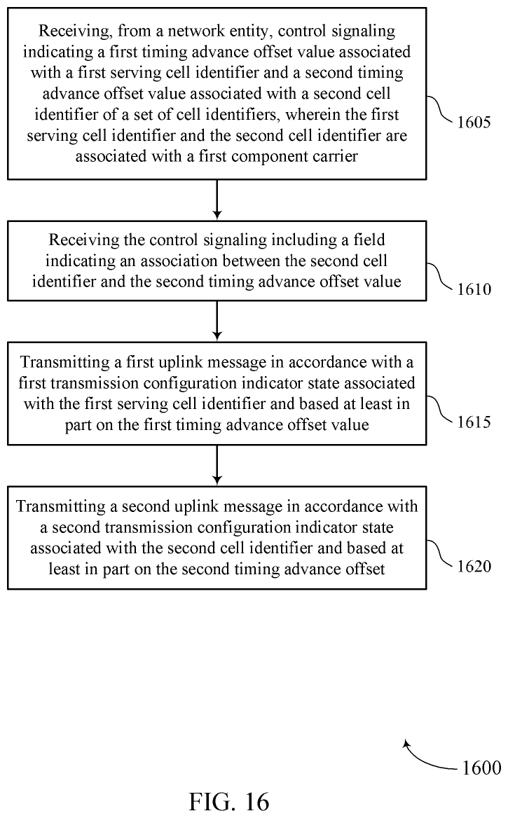

FIG. 16 shows a flowchart illustrating a method 1600 that supports timing advance offset configuration for inter-cell mDCI mTRP operation in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 1605 may be performed in accordance with examples as disclosed herein. In some examples, aspects of the operations of 1605 may be performed by a timing advance offset manager 925 as described with reference to FIG. 9.

At 1610, the method may include receiving the control signaling including a field indicating an association between the second cell identifier and the second timing advance offset value. The operations of 1610 may be performed in accordance with examples as disclosed herein. In some examples, aspects of the operations of 1610 may be performed by an additional timing advance offset indication manager 935 as described with reference to FIG. 9.

At 1615, the method may include transmit a first uplink message in accordance with a first TCI state associated with the first serving cell identifier and based on the first timing advance offset value. The operations of 1615 may be performed in accordance with examples as disclosed herein. In some examples, aspects of the operations of 1615 may be performed by a first TCI state uplink manager 930 as described with reference to FIG. 9.

At 1620, the method may include transmit a second uplink message in accordance with a second TCI state associated with the second cell identifier and based on the second timing advance offset. The operations of 1620 may be performed in accordance with examples as disclosed herein. In some examples, aspects of the operations of 1620 may be performed by a first TCI state uplink manager 930 as described with reference to FIG. 9.

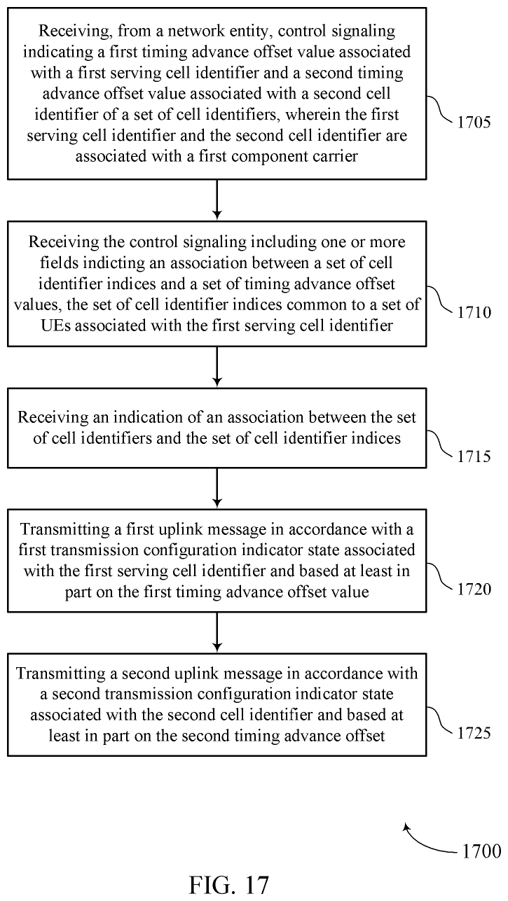

FIG. 17 shows a flowchart illustrating a method 1700 that supports timing advance offset configuration for inter-cell mDCI mTRP operation in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 1705 may be performed in accordance with examples as disclosed herein. In some examples, aspects of the operations of 1705 may be performed by a timing advance offset manager 925 as described with reference to FIG. 9.

At 1710, the method may include receiving the control signaling including one or more fields indicating an association between a set of cell identifier indices and a set of timing advance offset values, the set of cell identifier indices common to a set of UEs associated with the first serving cell identifier. The operations of 1710 may be performed in accordance with examples as disclosed herein. In some examples, aspects of the operations of 1710 may be performed by an additional timing advance offset indication manager 935 as described with reference to FIG. 9.

At 1715, the method may include receiving an indication of an association between the set of cell identifiers and the set of cell identifier indices. The operations of 1715 may be performed in accordance with examples as disclosed herein. In some examples, aspects of the operations of 1715 may be performed by a cell identifier index manager 940 as described with reference to FIG. 9.

At 1720, the method may include transmit a first uplink message in accordance with a first TCI state associated with the first serving cell identifier and based on the first timing advance offset value. The operations of 1720 may be performed in accordance with examples as disclosed herein. In some examples, aspects of the operations of 1720 may be performed by a first TCI state uplink manager 930 as described with reference to FIG. 9.

At 1725, the method may include transmit a second uplink message in accordance with a second TCI state associated with the second cell identifier and based on the second timing advance offset. The operations of 1725 may be performed in accordance with examples as disclosed herein. In some examples, aspects of the operations of 1725 may be performed by a first TCI state uplink manager 930 as described with reference to FIG. 9.

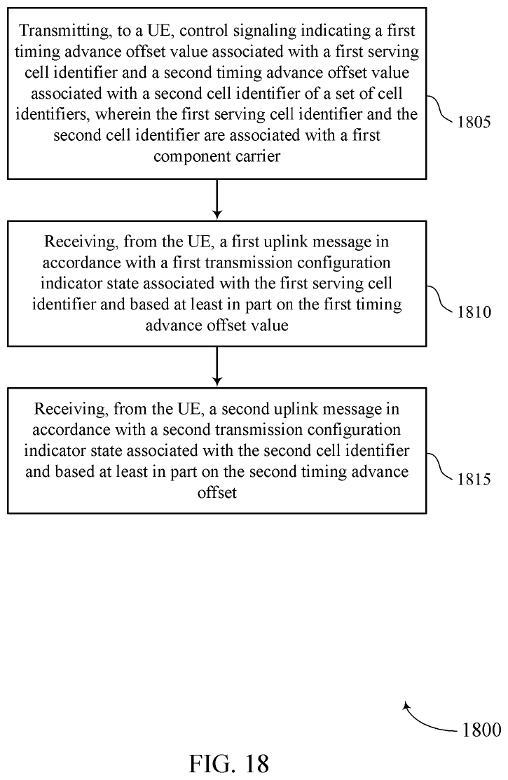

FIG. 18 shows a flowchart illustrating a method 1800 that supports timing advance offset configuration for inter-cell mDCI mTRP operation in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 1805 may be performed in accordance with examples as disclosed herein. In some examples, aspects of the operations of 1805 may be performed by a timing advance offset manager 1325 as described with reference to FIG. 13.

At 1810, the method may include receive, from the UE, a first uplink message in accordance with a first TCI state associated with the first serving cell identifier and based on the first timing advance offset value. The operations of 1810 may be performed in accordance with examples as disclosed herein. In some examples, aspects of the operations of 1810 may be performed by a first TCI state uplink manager 1330 as described with reference to FIG. 13.

At 1815, the method may include receive, from the UE, a second uplink message in accordance with a second TCI state associated with the second cell identifier and based on the second timing advance offset. The operations of 1815 may be performed in accordance with examples as disclosed herein. In some examples, aspects of the operations of 1815 may be performed by a second TCI state uplink manager 1335 as described with reference to FIG. 13.

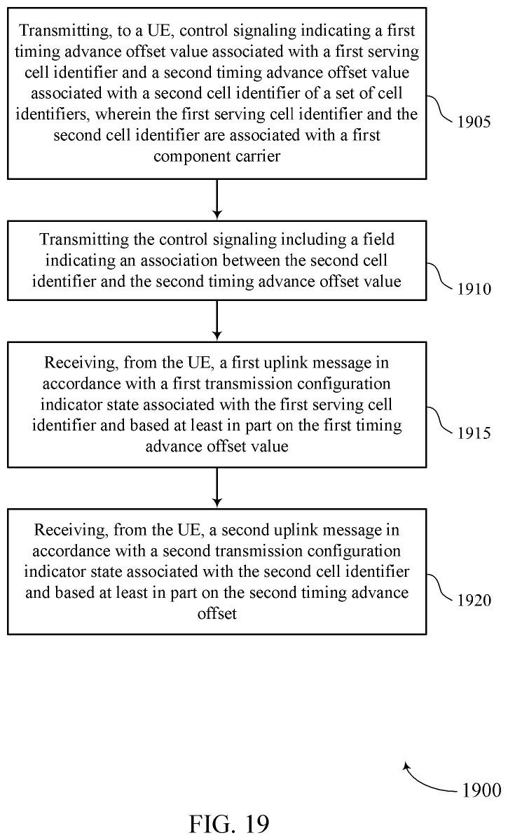

FIG. 19 shows a flowchart illustrating a method 1900 that supports timing advance offset configuration for inter-cell mDCI mTRP operation in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 1905 may be performed in accordance with examples as disclosed herein. In some examples, aspects of the operations of 1905 may be performed by a timing advance offset manager 1325 as described with reference to FIG. 13.

At 1910, the method may include transmitting the control signaling including a field indicating an association between the second cell identifier and the second timing advance offset value. The operations of 1910 may be performed in accordance with examples as disclosed herein. In some examples, aspects of the operations of 1910 may be performed by an additional timing advance offset indication manager 1340 as described with reference to FIG. 13.

At 1915, the method may include receive, from the UE, a first uplink message in accordance with a first TCI state associated with the first serving cell identifier and based on the first timing advance offset value. The operations of 1915 may be performed in accordance with examples as disclosed herein. In some examples, aspects of the operations of 1915 may be performed by a first TCI state uplink manager 1330 as described with reference to FIG. 13.

At 1920, the method may include receive, from the UE, a second uplink message in accordance with a second TCI state associated with the second cell identifier and based on the second timing advance offset. The operations of 1920 may be performed in accordance with examples as disclosed herein. In some examples, aspects of the operations of 1920 may be performed by a second TCI state uplink manager 1335 as described with reference to FIG. 13.

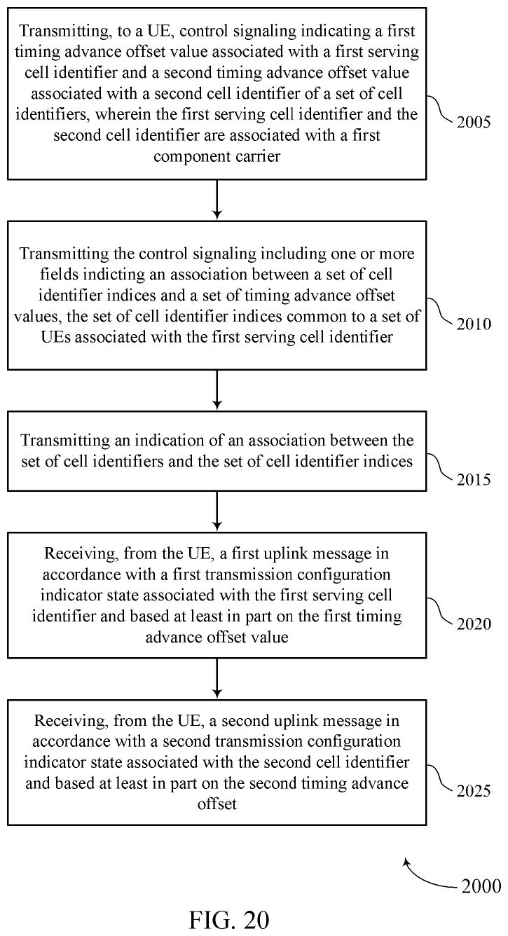

FIG. 20 shows a flowchart illustrating a method 2000 that supports timing advance offset configuration for inter-cell mDCI mTRP operation in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a UE, control signaling indicating a first timing advance offset value associated with a first serving cell identifier and a second timing advance offset value associated with a second cell identifier of a set of cell identifiers, where the first serving cell identifier and the second cell identifier are associated with a first CC. The operations of 2005 may be performed in accordance with examples as disclosed herein. In some examples, aspects of the operations of 2005 may be performed by a timing advance offset manager 1325 as described with reference to FIG. 13.

At 2010, the method may include transmitting the control signaling including one or more fields indicating an association between a set of cell identifier indices and a set of timing advance offset values, the set of cell identifier indices common to a set of UEs associated with the first serving cell identifier. The operations of 2010 may be performed in accordance with examples as disclosed herein. In some examples, aspects of the operations of 2010 may be performed by an additional timing advance offset indication manager 1340 as described with reference to FIG. 13.

At 2015, the method may include transmitting an indication of an association between the set of cell identifiers and the set of cell identifier indices. The operations of 2015 may be performed in accordance with examples as disclosed herein. In some examples, aspects of the operations of 2015 may be performed by a cell identifier index manager 1345 as described with reference to FIG. 13.

At 2020, the method may include receive, from the UE, a first uplink message in accordance with a first TCI state associated with the first serving cell identifier and based on the first timing advance offset value. The operations of 2020 may be performed in accordance with examples as disclosed herein. In some examples, aspects of the operations of 2020 may be performed by a first TCI state uplink manager 1330 as described with reference to FIG. 13.

At 2025, the method may include receive, from the UE, a second uplink message in accordance with a second TCI state associated with the second cell identifier and based on the second timing advance offset. The operations of 2025 may be performed in accordance with examples as disclosed herein. In some examples, aspects of the operations of 2025 may be performed by a second TCI state uplink manager 1335 as described with reference to FIG. 13.

The following provides an overview of aspects of the present disclosure:

Aspect 1: A method for wireless communications at a UE, comprising: receiving, from a network entity, control signaling indicating a first timing advance offset value associated with a first serving cell identifier and a second timing advance offset value associated with a second cell identifier of a set of cell identifiers, wherein the first serving cell identifier and the second cell identifier are associated with a first CC; transmit a first uplink message in accordance with a first TCI state associated with the first serving cell identifier and based at least in part on the first timing advance offset value; and transmit a second uplink message in accordance with a second TCI state associated with the second cell identifier and based at least in part on the second timing advance offset.

Aspect 2: The method of aspect 1, wherein receiving the control signaling comprises: receiving the control signaling including a field indicating an association between the second cell identifier and the second timing advance offset value.

Aspect 3: The method of aspect 1, wherein receiving the control signaling comprises: receiving the control signaling including one or more fields indicating an association between a set of cell identifier indices and a set of timing advance offset values, the set of cell identifier indices common to a set of UEs associated with the first serving cell identifier; and receiving an indication of an association between the set of cell identifiers and the set of cell identifier indices.

Aspect 4: The method of any of aspects 1 through 3, wherein receiving the control signaling comprises: receiving the control signaling indicating the first CC is associated with a first TAG and a second TAG, wherein the first timing advance offset value, the second timing advance offset value, and additional timing advance offset values associated with the set of cell identifiers are each associated with one of the first TAG or the second TAG; and receiving the control signaling indicating a second CC associated with the first TAG and a third timing advance offset value associated with the second CC, wherein the third timing advance offset value is associated with the first TAG, and wherein timing advance offset values associated with the first TAG in the first CC and the second CC are equal.

Aspect 5: The method of any of aspects 1 through 3, wherein receiving the control signaling comprises: receiving the control signaling indicating the first CC associated with a first TAG and a second TAG, wherein the first timing advance offset value, the second timing advance offset value, and additional timing advance offset values associated with the set of cell identifiers are each associated with one of the first TAG or the second TAG; and receiving the control signaling indicating a second CC associated with at least one of the first TAG or the second TAG and a third timing advance offset value associated with the second CC, wherein the third timing advance offset value is associated with the at least one of the first TAG or the second TAG, and wherein timing advance offset values associated with the at least one of the first TAG or the second TAG in the first CC and the second CC are equal.

Aspect 6: The method of any of aspects 1 through 3, wherein receiving the control signaling comprises: receiving the control signaling indicating the first CC is associated with a first TAG and a second TAG, wherein the first timing advance offset value, the second timing advance offset value, and additional timing advance offset values associated with the set of cell identifiers are each associated with one of the first TAG, the second TAG, or a third TAG; and receiving the control signaling indicating a second set of cell identifiers associated with a second CC, the second CC associated with at least one of the first TAG or the second TAG and a second set of timing advance offset values associated with the second set of cell identifiers, wherein a subset of timing advance offset values of the second set of timing advance offset values are associated with the at least one of the first TAG or the second TAG, and wherein timing advance offset values associated with the at least one of the first TAG or the second TAG in the first CC and the second CC are equal.

Aspect 7: The method of any of aspects 1 through 4, further comprising: receiving, from the network entity, second control signaling activating first one or more TCI states for a first CORESET pool index in the first CC, wherein the first CORESET pool index is associated with the first serving cell identifier and a first TAG; receiving, from the network entity, third control signaling activating second one or more TCI states for a second CORESET pool index in the first CC, wherein the second CORESET pool index is associated with the second cell identifier and a second TAG; and receiving, from the network entity, fourth control signaling activating third one or more TCI states associated with a second serving cell identifier for a second CC, wherein the second serving cell identifier is associated with the second TAG, and wherein the second timing advance offset value is equal to a third timing advance offset value associated with the second serving cell identifier.

Aspect 8: The method of any of aspects 1 through 3 or 5, further comprising: receiving, from the network entity, second control signaling activating first one or more TCI states for a first CORESET pool index in the first CC, wherein the first CORESET pool index is associated with the first serving cell identifier and a first TAG; receiving, from the network entity, third control signaling activating second one or more TCI states for a second CORESET pool index in the first CC, wherein the second CORESET pool index is associated with the second cell identifier and a second TAG; receiving, from the network entity, fourth control signaling activating third one or more TCI states associated with a third CORESET pool index for a second CC, wherein the third CORESET pool index is associated with a second serving cell identifier and the first TAG, and wherein the first timing advance offset value is equal to a third timing advance offset value associated with the third CORESET pool index of the second serving cell identifier; and receiving, from the network entity, fifth control signaling activating fourth one or more TCI states associated with a fourth CORESET pool index for the second CC, wherein the fourth CORESET pool index is associated with the second serving cell identifier and the second TAG, and wherein the second timing advance offset value is equal to a fourth timing advance offset value associated with the fourth CORESET pool index of the second serving cell identifier.

Aspect 9: The method of any of aspects 1 through 3 or 6, further comprising: receiving, from the network entity, second control signaling activating first one or more TCI states for a first CORESET pool index in the first CC, wherein the first CORESET pool index is associated with the first serving cell identifier and a first TAG; receiving, from the network entity, third control signaling activating second one or more TCI states for a second CORESET pool index in the first CC, wherein the second CORESET pool index is associated with the second cell identifier and a second TAG; receiving, from the network entity, fourth control signaling activating third one or more TCI states associated with a third CORESET pool index for a second CC, wherein the third CORESET pool index is associated with a second serving cell identifier and the first TAG, and wherein the first timing advance offset value is equal to a third timing advance offset value associated with the third CORESET pool index of the second serving cell identifier; and receiving, from the network entity, fifth control signaling activating fourth one or more TCI states associated with a fourth CORESET pool index for the second CC, wherein the fourth CORESET pool index is associated with a third cell identifier of a second set of cell identifiers associated with the second CC and a third TAG.

Aspect 10: The method of any of aspects 1 through 3 or 6, further comprising: receiving, from the network entity, second control signaling activating first one or more TCI states for a first CORESET pool index for the first CC, wherein the first CORESET pool index is associated with the first serving cell identifier and a first TAG; receiving, from the network entity, third control signaling activating second one or more TCI states for a second CORESET pool index for the first CC, wherein the second CORESET pool index is associated with the second cell identifier and a second TAG; receiving, from the network entity, fourth control signaling activating third one or more TCI states associated with a third CORESET pool index for a second CC, wherein the third CORESET pool index is associated with a third cell identifier of a second set of cell identifiers associated with the second CC and the second TAG, and wherein the first timing advance offset value is equal to a third timing advance offset value associated with the third cell identifier of the second set of cell identifiers; and receiving, from the network entity, fifth control signaling activating fourth one or more TCI states associated with a fourth CORESET pool index for the second CC, wherein the fourth CORESET pool index is associated with a second serving cell identifier and a third TAG.

Aspect 11: The method of any of aspects 1 through 3 or 6, further comprising: receiving, from the network entity, second control signaling activating first one or more TCI states for a first CORESET pool index for the first CC, wherein the first CORESET pool index is associated with the second cell identifier and a first TAG; receiving, from the network entity, third control signaling activating second one or more TCI states for a second CORESET pool index for the first CC, wherein the second CORESET pool index is associated with the first serving cell identifier and a second TAG; receiving, from the network entity, fourth control signaling activating third one or more TCI states associated with a third CORESET pool index for a second CC, wherein the third CORESET pool index is associated with a third cell identifier of a second set of cell identifiers associated with the second CC and a third TAG; and receiving, from the network entity, fifth control signaling activating fourth one or more TCI states associated with a fourth CORESET pool index for the second CC, wherein the fourth CORESET pool index is associated with a second serving cell identifier and the first TAG, and wherein the second timing advance offset value is equal to a third timing advance offset value associated with the second serving cell identifier.

Aspect 12: The method of any of aspects 1 through 3 or 6, further comprising: receiving, from the network entity, second control signaling activating first one or more TCI states for a first CORESET pool index for the first CC, wherein the first CORESET pool index is associated with the first serving cell identifier and a first TAG; receiving, from the network entity, third control signaling activating second one or more TCI state for a second CORESET pool index for the first CC, wherein the second CORESET pool index is associated with the second cell identifier and a second TAG; receiving, from the network entity, fourth control signaling activating third one or more TCI states associated with a third CORESET pool index for a second CC, wherein the third CORESET pool index is associated with a second serving cell identifier and a third TAG; and receiving, from the network entity, fifth control signaling activating fourth one or more TCI states associated with a fourth CORESET pool index for the second CC, wherein the fourth CORESET pool index is associated with a third cell identifier of a second set of cell identifiers associated with the second CC and the second TAG, and wherein the second timing advance offset value is equal to a third timing advance offset value associated with the third cell identifier.

Aspect 13: A method for wireless communications at a network entity, comprising: transmitting, to a UE, control signaling indicating a first timing advance offset value associated with a first serving cell identifier and a second timing advance offset value associated with a second cell identifier of a set of cell identifiers, wherein the first serving cell identifier and the second cell identifier are associated with a first CC; receive, from the UE, a first uplink message in accordance with a first TCI state associated with the first serving cell identifier and based at least in part on the first timing advance offset value; and receive, from the UE, a second uplink message in accordance with a second TCI state associated with the second cell identifier and based at least in part on the second timing advance offset.

Aspect 14: The method of aspect 13, wherein transmitting the control signaling comprises: transmitting the control signaling including a field indicating an association between the second cell identifier and the second timing advance offset value.

Aspect 15: The method of aspect 13, wherein transmitting the control signaling comprises: transmitting the control signaling including one or more fields indicating an association between a set of cell identifier indices and a set of timing advance offset values, the set of cell identifier indices common to a set of UEs associated with the first serving cell identifier; and transmitting an indication of an association between the set of cell identifiers and the set of cell identifier indices.

Aspect 16: The method of any of aspects 13 through 15, wherein transmitting the control signaling comprises: transmitting the control signaling indicating the first CC is associated with a first TAG and a second TAG, wherein the first timing advance offset value, the second timing advance offset value, and additional timing advance offset values associated with the set of cell identifiers are each associated with one of the first TAG or the second TAG; and transmitting the control signaling indicating a second CC associated with the first TAG and a third timing advance offset value associated with the second CC, wherein the third timing advance offset value is associated with the first TAG, and wherein timing advance offset values associated with the first TAG in the first CC and the second CC are equal.

Aspect 17: The method of any of aspects 13 through 15, wherein transmitting the control signaling comprises: transmitting the control signaling indicating the first CC associated with a first TAG and a second TAG, wherein the first timing advance offset value, the second timing advance offset value, and additional timing advance offset values associated with the set of cell identifiers are each associated with one of the first TAG or the second TAG; and transmitting the control signaling indicating a second CC associated with at least one of the first TAG or the second TAG and a third timing advance offset value associated with the second CC, wherein the third timing advance offset value is associated with the at least one of the first TAG or the second TAG, and wherein timing advance offset values associated with the at least one of the first TAG or the second TAG in the first CC and the second CC are equal.

Aspect 18: The method of any of aspects 13 through 15, wherein transmitting the control signaling comprises: transmitting the control signaling indicating the first CC associated with a first TAG and a second TAG, wherein the first timing advance offset value, the second timing advance offset value, and additional timing advance offset values associated with the set of cell identifiers are each associated with one of the first TAG, the second TAG, or a third TAG; and transmitting the control signaling indicating a second set of cell identifiers associated with a second CC, the second CC associated with at least one of the first TAG or the second TAG and a second set of timing advance offset values associated with the second set of cell identifiers, wherein a subset of timing advance offset values of the second set of timing advance offset values are associated with the at least one of the first TAG or the second TAG, and wherein timing advance offset values associated with the at least one of the first TAG or the second TAG in the first CC and the second CC are equal.

Aspect 19: The method of any of aspects 13 through 16, further comprising: transmitting, to the UE, second control signaling activating first one or more TCI states for a first CORESET pool index in the first CC, wherein the first CORESET pool index is associated with the first serving cell identifier and a first TAG; transmitting, to the UE, third control signaling activating second one or more TCI states for a second CORESET pool index in the first CC, wherein the second CORESET pool index is associated with the second cell identifier and a second TAG; and transmitting, to the UE, fourth control signaling activating third one or more TCI states associated with a second serving cell identifier for a second CC, wherein the second serving cell identifier is associated with the second TAG, and wherein the second timing advance offset value is equal to a third timing advance offset value associated with the second serving cell identifier.

Aspect 20: The method of any of aspects 13 through 15 or 17, further comprising: transmitting, to the UE, second control signaling activating first one or more TCI states for a first CORESET pool index in the first CC, wherein the first CORESET pool index is associated with the first serving cell identifier and a first TAG; transmitting, to the UE, third control signaling activating second one or more TCI states for a second CORESET pool index in the first CC, wherein the second CORESET pool index is associated with the second cell identifier and a second TAG; transmitting, to the UE, fourth control signaling activating third one or more TCI states associated with a third CORESET pool index for a second CC, wherein the third CORESET pool index is associated with a second serving cell identifier and the first TAG, and wherein the first timing advance offset value is equal to a third timing advance offset value associated with the third CORESET pool index of the second serving cell identifier; and transmitting, to the UE, fifth control signaling activating fourth one or more TCI states associated with a fourth CORESET pool index for the second CC, wherein the fourth CORESET pool index is associated with the second serving cell identifier and the second TAG, and wherein the second timing advance offset value is equal to a fourth timing advance offset value associated with the fourth CORESET pool index of the second serving cell identifier.

Aspect 21: The method of any of aspects 13 through 15 or 18, further comprising: transmitting, to the UE, second control signaling activating first one or more TCI states for a first CORESET pool index in the first CC, wherein the first CORESET pool index is associated with the first serving cell identifier and a first TAG; transmitting, to the UE, third control signaling activating second one or more TCI states for a second CORESET pool index in the first CC, wherein the second CORESET pool index is associated with the second cell identifier and a second TAG; transmitting, to the UE, fourth control signaling activating third one or more TCI states associated with a third CORESET pool index for a second CC, wherein the third CORESET pool index is associated with a second serving cell identifier and the first TAG, and wherein the first timing advance offset value is equal to a third timing advance offset value associated with the third CORESET pool index of the second serving cell identifier; and transmitting, to the UE, fifth control signaling activating fourth one or more TCI states associated with a fourth CORESET pool index for the second CC, wherein the fourth CORESET pool index is associated with a third cell identifier of a second set of cell identifiers associated with the second CC and a third TAG.

Aspect 22: The method of any of aspects 13 through 15 or 18, further comprising: transmitting, to the UE, second control signaling activating first one or more TCI states for a first CORESET pool index for the first CC, wherein the first CORESET pool index is associated with the first serving cell identifier and a first TAG; transmitting, to the UE, third control signaling activating second one or more TCI states for a second CORESET pool index for the first CC, wherein the second CORESET pool index is associated with the second cell identifier and a second TAG; transmitting, to the UE, fourth control signaling activating third one or more TCI states associated with a third CORESET pool index for a second CC, wherein the third CORESET pool index is associated with a third cell identifier of a second set of cell identifiers associated with the second CC and the second TAG, and wherein the first timing advance offset value is equal to a third timing advance offset value associated with the third cell identifier of the second set of cell identifiers; and transmitting, to the UE, fifth control signaling activating fourth one or more TCI states associated with a fourth CORESET pool index for the second CC, wherein the fourth CORESET pool index is associated with a second serving cell identifier and a third TAG.

Aspect 23: The method of any of aspects 13 through 15 or 18, further comprising: transmitting, to the UE, second control signaling activating first one or more TCI states for a first CORESET pool index for the first CC, wherein the first CORESET pool index is associated with the second cell identifier and a first TAG; transmitting, to the UE, third control signaling activating second one or more TCI states for a second CORESET pool index for the first CC, wherein the second CORESET pool index is associated with the first serving cell identifier and a second TAG; transmitting, to the UE, fourth control signaling activating third one or more TCI states associated with a third CORESET pool index for a second CC, wherein the third CORESET pool index is associated with a third cell identifier of a second set of cell identifiers associated with the second CC and a third TAG; and transmitting, to the UE, fifth control signaling activating fourth one or more TCI states associated with a fourth CORESET pool index for the second CC, wherein the fourth CORESET pool index is associated with a second serving cell identifier and the first TAG, and wherein the second timing advance offset value is equal to a third timing advance offset value associated with the second serving cell identifier.

Aspect 24: The method of any of aspects 13 through 15 or 18, further comprising: transmitting, to the UE, second control signaling activating first one or more TCI states for a first CORESET pool index for the first CC, wherein the first CORESET pool index is associated with the first serving cell identifier and a first TAG; transmitting, to the UE, third control signaling activating second one or more TCI state for a second CORESET pool index for the first CC, wherein the second CORESET pool index is associated with the second cell identifier and a second TAG; transmitting, to the UE, fourth control signaling activating third one or more TCI states associated with a third CORESET pool index for a second CC, wherein the third CORESET pool index is associated with a second serving cell identifier and a third TAG; and transmitting, to the UE, fifth control signaling activating fourth one or more TCI states associated with a fourth CORESET pool index for the second CC, wherein the fourth CORESET pool index is associated with a third cell identifier of a second set of cell identifiers associated with the second CC and the second TAG, and wherein the second timing advance offset value is equal to a third timing advance offset value associated with the third cell identifier.

Aspect 25: An apparatus for wireless communications at a UE, comprising a processor; memory coupled with the processor; and instructions stored in the memory and executable by the processor to cause the apparatus to perform a method of any of aspects 1 through 12.

Aspect 26: An apparatus for wireless communications at a UE, comprising at least one means for performing a method of any of aspects 1 through 12.

Aspect 27: A non-transitory computer-readable medium storing code for wireless communications at a UE, the code comprising instructions executable by a processor to perform a method of any of aspects 1 through 12.

Aspect 28: An apparatus for wireless communications at a network entity, comprising a processor; memory coupled with the processor; and instructions stored in the memory and executable by the processor to cause the apparatus to perform a method of any of aspects 13 through 24.

Aspect 29: An apparatus for wireless communications at a network entity, comprising at least one means for performing a method of any of aspects 13 through 24.

Aspect 30: A non-transitory computer-readable medium storing code for wireless communications at a network entity, the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a network entity, control signaling indicating a first timing advance offset value associated with a first serving cell identifier and a second timing advance offset value associated with a second cell identifier of a set of cell identifiers, wherein the first serving cell identifier and the second cell identifier are associated with a first component carrier;
transmit a first uplink message in accordance with a first transmission configuration indicator state associated with the first serving cell identifier and based at least in part on the first timing advance offset value; and
transmit a second uplink message in accordance with a second transmission configuration indicator state associated with the second cell identifier and based at least in part on the second timing advance offset.

2. The method of claim 1, wherein receiving the control signaling comprises:
receiving the control signaling including a field indicating an association between the second cell identifier and the second timing advance offset value.

3. The method of claim 1, wherein receiving the control signaling comprises:
receiving the control signaling including one or more fields indicating an association between a set of cell identifier indices and a set of timing advance offset values, the set of cell identifier indices common to a set of UEs associated with the first serving cell identifier; and
receiving an indication of an association between the set of cell identifiers and the set of cell identifier indices.

4. The method of claim 1, wherein receiving the control signaling comprises:
receiving the control signaling indicating the first component carrier is associated with a first timing advance group and a second timing advance group, wherein the first timing advance offset value, the second timing advance offset value, and additional timing advance offset values associated with the set of cell identifiers are each associated with one of the first timing advance group or the second timing advance group; and
receiving the control signaling indicating a second component carrier associated with the first timing advance group and a third timing advance offset value associated with the second component carrier, wherein the third timing advance offset value is associated with the first timing advance group, and wherein timing advance offset values associated with the first timing advance group in the first component carrier and the second component carrier are equal.

5. The method of claim 1, wherein receiving the control signaling comprises:
receiving the control signaling indicating the first component carrier associated with a first timing advance group and a second timing advance group, wherein the first timing advance offset value, the second timing advance offset value, and additional timing advance offset values associated with the set of cell identifiers are each associated with one of the first timing advance group or the second timing advance group; and
receiving the control signaling indicating a second component carrier associated with at least one of the first timing advance group or the second timing advance group and a third timing advance offset value associated with the second component carrier, wherein the third timing advance offset value is associated with the at least one of the first timing advance group or the second timing advance group, and wherein timing advance offset values associated with the at least one of the first timing advance group or the second timing advance group in the first component carrier and the second component carrier are equal.

6. The method of claim 1, wherein receiving the control signaling comprises:
receiving the control signaling indicating the first component carrier is associated with a first timing advance group and a second timing advance group, wherein the first timing advance offset value, the second timing advance offset value, and additional timing advance offset values associated with the set of cell identifiers are each associated with one of the first timing advance group, the second timing advance group, or a third timing advance group; and
receiving the control signaling indicating a second set of cell identifiers associated with a second component carrier, the second component carrier associated with at least one of the first timing advance group or the second timing advance group and a second set of timing advance offset values associated with the second set of cell identifiers, wherein a subset of timing advance offset values of the second set of timing advance offset values are associated with the at least one of the first timing advance group or the second timing advance group, and wherein timing advance offset values associated with the at least one of the first timing advance group or the second timing advance group in the first component carrier and the second component carrier are equal.

7. The method of claim 1, further comprising:
receiving, from the network entity, second control signaling activating first one or more transmission configuration indicator states for a first control resource set (CORESET) pool index in the first component carrier, wherein the first CORESET pool index is associated with the first serving cell identifier and a first timing advance group;
receiving, from the network entity, third control signaling activating second one or more transmission configuration indicator states for a second CORESET pool index in the first component carrier, wherein the second CORESET pool index is associated with the second cell identifier and a second timing advance group; and
receiving, from the network entity, fourth control signaling activating third one or more transmission configuration indicator states associated with a second serving cell identifier for a second component carrier, wherein the second serving cell identifier is associated with the second timing advance group, and wherein the second timing advance offset value is equal to a third timing advance offset value associated with the second serving cell identifier.

8. The method of claim 1, further comprising:
receiving, from the network entity, second control signaling activating first one or more transmission configuration indicator states for a first control resource set (CORESET) pool index in the first component carrier, wherein the first CORESET pool index is associated with the first serving cell identifier and a first timing advance group;
receiving, from the network entity, third control signaling activating second one or more transmission configuration indicator states for a second CORESET pool index in the first component carrier, wherein the second CORESET pool index is associated with the second cell identifier and a second timing advance group;
receiving, from the network entity, fourth control signaling activating third one or more transmission configuration indicator states associated with a third CORESET pool index for a second component carrier, wherein the third CORESET pool index is associated with a second serving cell identifier and the first timing advance group, and wherein the first timing advance offset value is equal to a third timing advance offset value associated with the third CORESET pool index of the second serving cell identifier; and
receiving, from the network entity, fifth control signaling activating fourth one or more transmission configuration indicator states associated with a fourth CORESET pool index for the second component carrier, wherein the fourth CORESET pool index is associated with the second serving cell identifier and the second timing advance group, and wherein the second timing advance offset value is equal to a fourth timing advance offset value associated with the fourth CORESET pool index of the second serving cell identifier.

9. The method of claim 1, further comprising:
receiving, from the network entity, second control signaling activating first one or more transmission configuration indicator states for a first control resource set (CORESET) pool index in the first component carrier, wherein the first CORESET pool index is associated with the first serving cell identifier and a first timing advance group;
receiving, from the network entity, third control signaling activating second one or more transmission configuration indicator states for a second CORESET pool index in the first component carrier, wherein the second CORESET pool index is associated with the second cell identifier and a second timing advance group;
receiving, from the network entity, fourth control signaling activating third one or more transmission configuration indicator states associated with a third CORESET pool index for a second component carrier, wherein the third CORESET pool index is associated with a second serving cell identifier and the first timing advance group, and wherein the first timing advance offset value is equal to a third timing advance offset value associated with the third CORESET pool index of the second serving cell identifier; and
receiving, from the network entity, fifth control signaling activating fourth one or more transmission configuration indicator states associated with a fourth CORESET pool index for the second component carrier, wherein the fourth CORESET pool index is associated with a third cell identifier of a second set of cell identifiers associated with the second component carrier and a third timing advance group.

10. The method of claim 1, further comprising:
receiving, from the network entity, second control signaling activating first one or more transmission configuration indicator states for a first control resource set (CORESET) pool index for the first component carrier, wherein the first CORESET pool index is associated with the first serving cell identifier and a first timing advance group;
receiving, from the network entity, third control signaling activating second one or more transmission configuration indicator states for a second CORESET pool index for the first component carrier, wherein the second CORESET pool index is associated with the second cell identifier and a second timing advance group;
receiving, from the network entity, fourth control signaling activating third one or more transmission configuration indicator states associated with a third CORESET pool index for a second component carrier, wherein the third CORESET pool index is associated with a third cell identifier of a second set of cell identifiers associated with the second component carrier and the second timing advance group, and wherein the first timing advance offset value is equal to a third timing advance offset value associated with the third cell identifier of the second set of cell identifiers; and
receiving, from the network entity, fifth control signaling activating fourth one or more transmission configuration indicator states associated with a fourth CORESET pool index for the second component carrier, wherein the fourth CORESET pool index is associated with a second serving cell identifier and a third timing advance group.

11. The method of claim 1, further comprising:
receiving, from the network entity, second control signaling activating first one or more transmission configuration indicator states for a first control resource set (CORESET) pool index for the first component carrier, wherein the first CORESET pool index is associated with the second cell identifier and a first timing advance group;
receiving, from the network entity, third control signaling activating second one or more transmission configuration indicator states for a second CORESET pool index for the first component carrier, wherein the second CORESET pool index is associated with the first serving cell identifier and a second timing advance group;
receiving, from the network entity, fourth control signaling activating third one or more transmission configuration indicator states associated with a third CORESET pool index for a second component carrier, wherein the third CORESET pool index is associated with a third cell identifier of a second set of cell identifiers associated with the second component carrier and a third timing advance group; and
receiving, from the network entity, fifth control signaling activating fourth one or more transmission configuration indicator states associated with a fourth CORESET pool index for the second component carrier, wherein the fourth CORESET pool index is associated with a second serving cell identifier and the first timing advance group, and wherein the second timing advance offset value is equal to a third timing advance offset value associated with the second serving cell identifier.

12. The method of claim 1, further comprising:
receiving, from the network entity, second control signaling activating first one or more transmission configuration indicator states for a first control resource set (CORESET) pool index for the first component carrier, wherein the first CORESET pool index is associated with the first serving cell identifier and a first timing advance group;
receiving, from the network entity, third control signaling activating second one or more transmission configuration indicator state for a second CORESET pool index for the first component carrier, wherein the second CORESET pool index is associated with the second cell identifier and a second timing advance group;
receiving, from the network entity, fourth control signaling activating third one or more transmission configuration indicator states associated with a third CORESET pool index for a second component carrier, wherein the third CORESET pool index is associated with a second serving cell identifier and a third timing advance group; and
receiving, from the network entity, fifth control signaling activating fourth one or more transmission configuration indicator states associated with a fourth CORESET pool index for the second component carrier, wherein the fourth CORESET pool index is associated with a third cell identifier of a second set of cell identifiers associated with the second component carrier and the second timing advance group, and wherein the second timing advance offset value is equal to a third timing advance offset value associated with the third cell identifier.

13. A method for wireless communications at a network entity, comprising:
transmitting, to a user equipment (UE), control signaling indicating a first timing advance offset value associated with a first serving cell identifier and a second timing advance offset value associated with a second cell identifier of a set of cell identifiers, wherein the first serving cell identifier and the second cell identifier are associated with a first component carrier;
receive, from the UE, a first uplink message in accordance with a first transmission configuration indicator state associated with the first serving cell identifier and based at least in part on the first timing advance offset value; and
receive, from the UE, a second uplink message in accordance with a second transmission configuration indicator state associated with the second cell identifier and based at least in part on the second timing advance offset.

14. The method of claim 13, wherein transmitting the control signaling comprises:
transmitting the control signaling including a field indicating an association between the second cell identifier and the second timing advance offset value.

15. The method of claim 13, wherein transmitting the control signaling comprises:
transmitting the control signaling including one or more fields indicating an association between a set of cell identifier indices and a set of timing advance offset values, the set of cell identifier indices common to a set of UEs associated with the first serving cell identifier; and
transmitting an indication of an association between the set of cell identifiers and the set of cell identifier indices.

16. The method of claim 13, wherein transmitting the control signaling comprises:
transmitting the control signaling indicating the first component carrier is associated with a first timing advance group and a second timing advance group, wherein the first timing advance offset value, the second timing advance offset value, and additional timing advance offset values associated with the set of cell identifiers are each associated with one of the first timing advance group or the second timing advance group; and
transmitting the control signaling indicating a second component carrier associated with the first timing advance group and a third timing advance offset value associated with the second component carrier, wherein the third timing advance offset value is associated with the first timing advance group, and wherein timing advance offset values associated with the first timing advance group in the first component carrier and the second component carrier are equal.

17. The method of claim 13, wherein transmitting the control signaling comprises:
transmitting the control signaling indicating the first component carrier associated with a first timing advance group and a second timing advance group, wherein the first timing advance offset value, the second timing advance offset value, and additional timing advance offset values associated with the set of cell identifiers are each associated with one of the first timing advance group or the second timing advance group; and
transmitting the control signaling indicating a second component carrier associated with at least one of the first timing advance group or the second timing advance group and a third timing advance offset value associated with the second component carrier, wherein the third timing advance offset value is associated with the at least one of the first timing advance group or the second timing advance group, and wherein timing advance offset values associated with the at least one of the first timing advance group or the second timing advance group in the first component carrier and the second component carrier are equal.

18. The method of claim 13, wherein transmitting the control signaling comprises:
transmitting the control signaling indicating the first component carrier associated with a first timing advance group and a second timing advance group, wherein the first timing advance offset value, the second timing advance offset value, and additional timing advance offset values associated with the set of cell identifiers are each associated with one of the first timing advance group, the second timing advance group, or a third timing advance group; and
transmitting the control signaling indicating a second set of cell identifiers associated with a second component carrier, the second component carrier associated with at least one of the first timing advance group or the second timing advance group and a second set of timing advance offset values associated with the second set of cell identifiers, wherein a subset of timing advance offset values of the second set of timing advance offset values are associated with the at least one of the first timing advance group or the second timing advance group, and wherein timing advance offset values associated with the at least one of the first timing advance group or the second timing advance group in the first component carrier and the second component carrier are equal.

19. The method of claim 13, further comprising:
transmitting, to the UE, second control signaling activating first one or more transmission configuration indicator states for a first control resource set (CORESET) pool index in the first component carrier, wherein the first CORESET pool index is associated with the first serving cell identifier and a first timing advance group;
transmitting, to the UE, third control signaling activating second one or more transmission configuration indicator states for a second CORESET pool index in the first component carrier, wherein the second CORESET pool index is associated with the second cell identifier and a second timing advance group; and
transmitting, to the UE, fourth control signaling activating third one or more transmission configuration indicator states associated with a second serving cell identifier for a second component carrier, wherein the second serving cell identifier is associated with the second timing advance group, and wherein the second timing advance offset value is equal to a third timing advance offset value associated with the second serving cell identifier.

20. The method of claim 13, further comprising:
transmitting, to the UE, second control signaling activating first one or more transmission configuration indicator states for a first control resource set (CORESET) pool index in the first component carrier, wherein the first CORESET pool index is associated with the first serving cell identifier and a first timing advance group;
transmitting, to the UE, third control signaling activating second one or more transmission configuration indicator states for a second CORESET pool index in the first component carrier, wherein the second CORESET pool index is associated with the second cell identifier and a second timing advance group;
transmitting, to the UE, fourth control signaling activating third one or more transmission configuration indicator states associated with a third CORESET pool index for a second component carrier, wherein the third CORESET pool index is associated with a second serving cell identifier and the first timing advance group, and wherein the first timing advance offset value is equal to a third timing advance offset value associated with the third CORESET pool index of the second serving cell identifier; and
transmitting, to the UE, fifth control signaling activating fourth one or more transmission configuration indicator states associated with a fourth CORESET pool index for the second component carrier, wherein the fourth CORESET pool index is associated with the second serving cell identifier and the second timing advance group, and wherein the second timing advance offset value is equal to a fourth timing advance offset value associated with the fourth CORESET pool index of the second serving cell identifier.

21. The method of claim 13, further comprising:
transmitting, to the UE, second control signaling activating first one or more transmission configuration indicator states for a first control resource set (CORESET) pool index in the first component carrier, wherein the first CORESET pool index is associated with the first serving cell identifier and a first timing advance group;
transmitting, to the UE, third control signaling activating second one or more transmission configuration indicator states for a second CORESET pool index in the first component carrier, wherein the second CORESET pool index is associated with the second cell identifier and a second timing advance group;
transmitting, to the UE, fourth control signaling activating third one or more transmission configuration indicator states associated with a third CORESET pool index for a second component carrier, wherein the third CORESET pool index is associated with a second serving cell identifier and the first timing advance group, and wherein the first timing advance offset value is equal to a third timing advance offset value associated with the third CORESET pool index of the second serving cell identifier; and
transmitting, to the UE, fifth control signaling activating fourth one or more transmission configuration indicator states associated with a fourth CORESET pool index for the second component carrier, wherein the fourth CORESET pool index is associated with a third cell identifier of a second set of cell identifiers associated with the second component carrier and a third timing advance group.

22. The method of claim 13, further comprising:
transmitting, to the UE, second control signaling activating first one or more transmission configuration indicator states for a first control resource set (CORESET) pool index for the first component carrier, wherein the first CORESET pool index is associated with the first serving cell identifier and a first timing advance group;
transmitting, to the UE, third control signaling activating second one or more transmission configuration indicator states for a second CORESET pool index for the first component carrier, wherein the second CORESET pool index is associated with the second cell identifier and a second timing advance group;
transmitting, to the UE, fourth control signaling activating third one or more transmission configuration indicator states associated with a third CORESET pool index for a second component carrier, wherein the third CORESET pool index is associated with a third cell identifier of a second set of cell identifiers associated with the second component carrier and the second timing advance group, and wherein the first timing advance offset value is equal to a third timing advance offset value associated with the third cell identifier of the second set of cell identifiers; and
transmitting, to the UE, fifth control signaling activating fourth one or more transmission configuration indicator states associated with a fourth CORESET pool index for the second component carrier, wherein the fourth CORESET pool index is associated with a second serving cell identifier and a third timing advance group.

23. The method of claim 13, further comprising:
transmitting, to the UE, second control signaling activating first one or more transmission configuration indicator states for a first control resource set (CORESET) pool index for the first component carrier, wherein the first CORESET pool index is associated with the second cell identifier and a first timing advance group;
transmitting, to the UE, third control signaling activating second one or more transmission configuration indicator states for a second CORESET pool index for the first component carrier, wherein the second CORESET pool index is associated with the first serving cell identifier and a second timing advance group;
transmitting, to the UE, fourth control signaling activating third one or more transmission configuration indicator states associated with a third CORESET pool index for a second component carrier, wherein the third CORESET pool index is associated with a third cell identifier of a second set of cell identifiers associated with the second component carrier and a third timing advance group; and
transmitting, to the UE, fifth control signaling activating fourth one or more transmission configuration indicator states associated with a fourth CORESET pool index for the second component carrier, wherein the fourth CORESET pool index is associated with a second serving cell identifier and the first timing advance group, and wherein the second timing advance offset value is equal to a third timing advance offset value associated with the second serving cell identifier.

24. The method of claim 13, further comprising:
transmitting, to the UE, second control signaling activating first one or more transmission configuration indicator states for a first control resource set (CORESET) pool index for the first component carrier, wherein the first CORESET pool index is associated with the first serving cell identifier and a first timing advance group;
transmitting, to the UE, third control signaling activating second one or more transmission configuration indicator state for a second CORESET pool index for the first component carrier, wherein the second CORESET pool index is associated with the second cell identifier and a second timing advance group;
transmitting, to the UE, fourth control signaling activating third one or more transmission configuration indicator states associated with a third CORESET pool index for a second component carrier, wherein the third CORESET pool index is associated with a second serving cell identifier and a third timing advance group; and
transmitting, to the UE, fifth control signaling activating fourth one or more transmission configuration indicator states associated with a fourth CORESET pool index for the second component carrier, wherein the fourth CORESET pool index is associated with a third cell identifier of a second set of cell identifiers associated with the second component carrier and the second timing advance group, and wherein the second timing advance offset value is equal to a third timing advance offset value associated with the third cell identifier.

25. An apparatus for wireless communications at a user equipment (UE), comprising:
a processor;
memory coupled with the processor; and
instructions stored in the memory and executable by the processor to cause the apparatus to:
receive, from a network entity, control signaling indicating a first timing advance offset value associated with a first serving cell identifier and a second timing advance offset value associated with a second cell identifier of a set of cell identifiers, wherein the first serving cell identifier and the second cell identifier are associated with a first component carrier;
transmit a first uplink message in accordance with a first transmission configuration indicator state associated with the first serving cell identifier and based at least in part on the first timing advance offset value; and
transmit a second uplink message in accordance with a second transmission configuration indicator state associated with the second cell identifier and based at least in part on the second timing advance offset.

26. The apparatus of claim 25, wherein the instructions to receive the control signaling are executable by the processor to cause the apparatus to:
receive the control signaling including a field indicating an association between the second cell identifier and the second timing advance offset value.

27. The apparatus of claim 25, wherein the instructions to receive the control signaling are executable by the processor to cause the apparatus to:
receive the control signaling including one or more fields indicating an association between a set of cell identifier indices and a set of timing advance offset values, the set of cell identifier indices common to a set of UEs associated with the first serving cell identifier; and
receive an indication of an association between the set of cell identifiers and the set of cell identifier indices.

28. The apparatus of claim 25, wherein the instructions to receive the control signaling are executable by the processor to cause the apparatus to:
receive the control signaling indicating the first component carrier is associated with a first timing advance group and a second timing advance group, wherein the first timing advance offset value, the second timing advance offset value, and additional timing advance offset values associated with the set of cell identifiers are each associated with one of the first timing advance group or the second timing advance group; and
receive the control signaling indicating a second component carrier associated with the first timing advance group and a third timing advance offset value associated with the second component carrier, wherein the third timing advance offset value is associated with the first timing advance group, and wherein timing advance offset values associated with the first timing advance group in the first component carrier and the second component carrier are equal.

29. The apparatus of claim 25, wherein the instructions to receive the control signaling are executable by the processor to cause the apparatus to:
receive the control signaling indicating the first component carrier associated with a first timing advance group and a second timing advance group, wherein the first timing advance offset value, the second timing advance offset value, and additional timing advance offset values associated with the set of cell identifiers are each associated with one of the first timing advance group or the second timing advance group; and
receive the control signaling indicating a second component carrier associated with at least one of the first timing advance group or the second timing advance group and a third timing advance offset value associated with the second component carrier, wherein the third timing advance offset value is associated with the at least one of the first timing advance group or the second timing advance group, and wherein timing advance offset values associated with the at least one of the first timing advance group or the second timing advance group in the first component carrier and the second component carrier are equal.

30. An apparatus for wireless communications at a network entity, comprising:
a processor;
memory coupled with the processor; and
instructions stored in the memory and executable by the processor to cause the apparatus to:
transmit, to a user equipment (UE), control signaling indicating a first timing advance offset value associated with a first serving cell identifier and a second timing advance offset value associated with a second cell identifier of a set of cell identifiers, wherein the first serving cell identifier and the second cell identifier are associated with a first component carrier;
receive, from the UE, a first uplink message in accordance with a first transmission configuration indicator state associated with the first serving cell identifier and based at least in part on the first timing advance offset value; and
receive, from the UE, a second uplink message in accordance with a second transmission configuration indicator state associated with the second cell identifier and based at least in part on the second timing advance offset.
